(19) United States
(12) Patent Application Publication
(10) Pub. No.: US 2007/0271194 A1
(43) Pub. Date: Nov. 22, 2007

(54) Products and Processes for Providing Offers for Products Dispensed from a Dispensing Device

(76) Inventors: Jay S. Walker, Ridgefield, CT (US); Paul T. Breitenbach, Wilton, CT (US); Daniel E. Tedesco, Shelton, CT (US); James A. Jorasch, New York, NY (US); Russell P. Sammon, San Francisco, CA (US); Geoffrey M. Gelman, Brooklyn, NY (US); Magdalena M. Fincham, Ridgefield, CT (US); Leonardo A. Booth, New Haven, CT (US); Steven M. Santisi, Ridgefield, CT (US)

Correspondence Address: WALKER DIGITAL MANAGEMENT, LLC, 2 HIGH RIDGE PARK, STAMFORD, CT, 06905, US

(21) Appl. No.: 11/568,658

(22) PCT Filed: May 4, 2005
(86) PCT No.: PCT/US05/15572

§ 371 Date: Jun. 1, 2007

Related U.S. Application Data
(60) Provisional application No. 60/568,057, filed on May 4, 2004.

(51) Int. Cl. G06Q 20/00

(52) U.S. Cl. 705/80

(57) ABSTRACT

According to an embodiment, a method includes providing an offer to enter into a forward commitment agreement, and then receiving an acceptance of the offer. A code is made available after receiving the acceptance. It is determined whether the code has been presented to a vending machine after the step of making the code available. A product is dispensed from a vending machine after the step of determination.

The present application claims the benefit of priority of U.S. Provisional Patent Application Ser. No. 60/568,057, filed May 4, 2004, entitled “APPARATUS, SYSTEMS AND METHODS FOR FACILITATING THIRD PARTY SPONSORED OFFERS FOR AUTOMATIC SALES MACHINE PRODUCTS”, the entirety of which is incorporated herein by reference.

### BRIEF DESCRIPTION OF THE DRAWINGS

FIG. 1A illustrates an example system according to an embodiment of the present invention.

FIG. 1B illustrates another example system according to an embodiment of the present invention,

FIG. 2 illustrates an example of a controller according to an embodiment of the present invention.

FIG. 3 illustrates an example of a dispensing device according to an embodiment of the present invention.

FIG. 4 illustrates an example of a merchant device according to an embodiment of the present invention.

FIG. 5 is a table illustrating an example data structure of an example forward commitment database according to an embodiment of the present invention.

FIG. 6 is a table illustrating an example data structure of an example of customer database according to an embodiment of the present invention.

FIG. 7 is a table illustrating an example data structure of an example merchant database according to an embodiment of the present invention.

FIG. 8 is a table illustrating an example data structure of an example dispensing devices database according to an embodiment of the present invention.

FIG. 9 illustrates an exemplary process for offering a forward commitment at a dispensing device according to an embodiment of the present invention.

### DETAILED DESCRIPTION

Terms

The term “product” means any machine, manufacture and/or composition of matter as contemplated by 35 U.S.C. § 101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) embodiments of the disclosed invention(s)”, unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

Each process (whether called a method, algorithm or otherwise) includes one or more steps, and therefore a reference to a “step” of a process has an inherent antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Similarly, where more than one device or article is described herein (whether or not they cooperate), a single device/article may alternatively be used in place of the more than one device or article that is described.

The functionality and/or the features of a device that is described may be alternatively embodied by one or more other devices which are not explicitly described as having such functionality/features. Thus, other embodiments need not include the described device itself.

Disclosed Examples are not Limiting

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. Those skilled in the art will recognize that the disclosed invention(s) may be practiced with various modifications and alterations. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Neither the Title (set forth at the beginning of the first page of this patent application) nor the Abstract (set forth at the end of this patent application) is to be taken as limiting in any way as the scope of the disclosed invention(s).

Devices that are in communication with each other need not be in continuous communication with each other, unless expressly specified otherwise. In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Computing

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of known media in a number of well-known manners. In some embodiments, hard-wired circuitry or custom hardware may be used in place of, or in combination with, software instructions for implementation of the processes. Thus, embodiments are not limited to any specific combination of hardware and software

A “processor” means any one or more microprocessors, central processing units (CPUs), computing devices, microcontrollers, digital signal processors, or like devices.

The term “computer-readable medium” refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, and (ii) other memory structures besides databases may be readily employed.

Continuing Applications

The present disclosure provides, to one of ordinary skill in the art, an enabling description of several embodiments and/or inventions. Some of these embodiments and/or inventions may not be claimed in the present application, but may nevertheless be claimed in one or more continuing applications which claim the benefit of priority of the present application.

### INTRODUCTION AND EXAMPLE EMBODIMENTS

According to various embodiments, a benefit is provided to a customer through a benefit-dispensing device if the customer agrees to do business with (e.g., transact with) a merchant in the future. The merchant may agree with an operator of the benefit-dispensing device to reimburse the operator for the cost of the benefit.

Thus, this embodiment can permit the merchant to obtain a new customer for the cost of the benefit. Further, because the customer can obtain an immediate benefit from the benefit-dispensing device, the customer is encouraged to accept the offer to enter a forward commitment agreement with the merchant.

In some embodiments, an offer to enter a forward commitment agreement is provided to a customer via a device capable of dispensing a benefit.

In other embodiments, a forward commitment agreement is offered to a customer via a user device, such as a cellular telephone, and a corresponding benefit is dispensed from a benefit-dispensing machine, such as a vending machine.

For example, a thirsty customer may approach a beverage vending machine, intending to purchase a beverage, but realize that he does not have enough money to purchase any beverage from the vending machine. However, the customer may see a sign affixed to the vending machine that reads “Thirsty? Let Sports Illustrated® buy you a drink. Just call 1 (800) 555-5555 to subscribe to 12 issues at the bargain price of $18”. The customer may use his cellular telephone to call the number, and a controller associated with the publisher of Sports Illustrated® magazine may thereafter receive information identifying the customer as well as an indication of the customer's acceptance of the subscription offer. After the customer registers for the offered subscription, the controller may make an alphanumeric code available to the user device (e.g., by outputting a code to the user device). Subsequently, the customer may present the code to the vending machine (e.g., the customer enters the code via an input device of the vending machine). The vending machine may be configured to dispense a beverage of the customer's choice upon presentation of the code. The vending machine may record the fact that the code has been presented and/or the fact that the beverage was dispensed, so that the operator of the vending machine can seek reimbursement from the magazine publisher at a later time (e.g. at the end of a fill period).

According to other embodiments, a system comprises a controller in communication with one or more benefit-dispensing devices and one or more merchant devices. Merchants create forward commitment agreements to be offered to customers. Such agreements specify a benefit that will be provided to a customer immediately if the customer agrees to fulfill a commitment in the future. Using a merchant device, a merchant then communicates descriptions of the forward commitment agreements to the controller. When a customer subsequently accesses or approaches a benefit-dispensing device, the controller, via the benefit-dispensing device or a user device, offers a forward commitment agreement to the customer. If the customer chooses to enter into the forward commitment agreement, then the benefit-dispensing device provides the customer with an immediate benefit. In some embodiments, the merchant subsequently reimburses the controller for the benefit provided to the customer.

In some embodiments, forward commitment agreements are offered to customers based on the previous offering, acceptance, and/or performance of forward commitment agreements. For example, customers who have previously been offered a particular forward commitment offer may not be offered the same offer in the future. Additionally or alternatively, customers who have previously accepted a particular forward commitment offer may not be offered the same offer in the future. Further, customers who have not performed in accordance with forward commitment agreements may not be provided with one or more offers in the future.

Further, some embodiments may also include verifying that a customer fulfills a forward commitment. If the customer does not, a consequence, as defined in the forward commitment agreement, may be imposed. For example, if a customer has not paid for a subscription to a magazine offered by a merchant, the customer may not be provided with forward commitment offers in the future.

Various embodiments help merchants and other sellers facilitate automated sales, acquire new customers, and/or establish relationships with customers. For example, various embodiments allow a merchant's customer acquisition budget to be used for direct acquisitions (e.g., money is provided to a person in exchange for the person becoming a new customer), rather than for uncertain advertising campaigns (which may not acquire significant a number of new customers regardless of expenditure). Various embodiments can also reduce a merchant's dependence on the labor otherwise required to acquire and sell to customers because that merchant would employ less personnel to acquire customers. Accordingly, such embodiments provide a merchant with an alternative to hiring, training and retaining sales staff or other personnel to acquire and sell to customers.

Various embodiments provide the offer of a forward commitment and a corresponding benefit at a time when a customer may be particularly motivated to accept the benefit and/or assume the commitment. The customer can receive an immediate and tangible benefit at a time when he may greatly need or want it. Thus, a customer may be highly motivated to enter into forward commitment agreements.

### Definitions

The term “ATM card” shall refer to a product that is capable of storing information about a customer who is a bank customer or owner of a bank account. This information may include information which identifies the customer, information which identifies the account, and/or information about the bank account. The ATM card may be machine readable (e.g., by an automated teller machine) in a known manner.

The term “casino” shall refer to the owner/operator of gaming devices, agents thereof, and/or any entity who may profit from players' use of the gaming devices.

The term “consequence” shall refer to a result that is imposed or enforced if a customer who is a party to a forward commitment agreement does not fulfill an associated forward commitment. Consequences may include charging a penalty to a financial account, bringing legal action, making a public disclosure (or a disclosure to a credit reporting agency) regarding the customer's failure to fulfill his commitment, or barring a customer from future use of a benefit-dispensing device.

The term “controller” shall refer to a device that may be in communication with a merchant device and/or a plurality of benefit-dispensing devices, and may be capable of facilitating communications to and from each. In some embodiments, a controller may be part of, or may comprise, a benefit-dispensing device, such as a vending machine.

The terms “fill period” and “sales period” shall be synonymous and shall each refer to the period of time between restock dates.

The terms “forward commitment agreement” and “commitment agreement” shall be synonymous and shall each refer to an agreement (e.g., an agreement between a merchant and a customer) that includes at least one term that specifies a forward commitment and at least one term that specifies a benefit (e.g., a benefit to be conferred upon the customer). A forward commitment agreement may have a provision for a transfer, assignment, and/or buyout (e.g., a manner of modifying or dissolving the forward commitment agreement), for example, to be applicable in the event that the entity bound by the forward commitment is unable or unwilling to fulfill it.

The term “forward commitment” shall refer to a commitment to do one or more of the following: purchase, use, lend, borrow, sell, lease, and/or license a product; perform work; provide an opinion; make a donation or contribution; assume an obligation; and/or answer a question. A customer may enter into a forward commitment agreement and, as a result, the customer assumes, or becomes bound to, a forward commitment (e.g., the customer becomes obligated to purchase a product). Once the terms of a forward commitment agreement have been satisfied, a forward commitment may be considered as having been fulfilled.

Further, a forward commitment may involve one or more parties and one or more obligations. For example, a forward commitment may commit (i) one person to perform one task, (ii) one person to perform a plurality of tasks, (iii) a plurality of people to each perform one task, (iv) a plurality of people to cooperatively perform one task, or (v) a (specified or unspecified) subset of a plurality of people to perform one or more tasks individually or cooperatively. A forward commitment may commit an entity to perform tasks periodically, to perform a task within a certain time period, or to perform a task conditionally based on a related or unrelated, random or non-random event and/or outcome. A forward commitment may be defined and/or specified by the entity fulfilling the forward commitment, by a merchant or other party benefiting from the fulfillment of the forward commitment, and/or by a third party. A forward commitment may require the fulfillment of a plurality of milestone tasks. If an entity fails to meet a milestone, then the forward commitment may be deemed unfulfilled. Meeting a particular milestone may not necessarily indicate that the forward commitment has been fulfilled.

The term “frequent shopper card” shall refer to a product that is capable of storing information about a customer who is a shopper (e.g., a shopper at a particular merchant such as a particular grocery store). This information may include information which identifies the customer and information regarding the shopping history (e.g., previous purchases) of the customer. The frequent shopper card may be machine readable (e.g., by a POS terminal) in a known manner.

The terms “full price” and “retail price” shall be synonymous and shall each refer to the price normally or typically charged for the purchase of a given product, typically in terms of the purchase of one unit of the given product.

The term “gaming device” shall refer to any gaming machine, including slot machines, video poker machines, video bingo machines, video keno machines, video blackjack machines, video lottery terminals, etc. that is capable of dispensing value (e.g., in the form of credit, cashless gaming receipts, cash and/or gambling tokens). Gaming devices may or may not be owned by a casino, may or may not exist within a casino, may or may not be stand alone or networked, may or may not be operating in a Class II and/or Class III gaming classification as defined in 25 U.S.C. § 2703.

The term “input device” shall refer to a device that is capable of receiving an input. An input device may communicate with or be part of another device (e.g. a point of sale terminal, a point of display terminal, a user device, a merchant device, a vending machine, a benefit-dispensing device, a controller). Some examples of input devices include: a bar-code scanner, a magnetic stripe reader, a computer keyboard, a point-of-sale terminal keypad, a vending machine keypad, a touch-screen, a microphone, an infrared sensor, a sonic ranger, a computer port, a video camera, a digital camera, a GPS receiver, a motion sensor, a radio frequency identification (RFID) receiver, a RF receiver, a thermometer, a pressure sensing pad, and a weight scale.

The term “I/O device” shall refer to any combination of one or more input devices and/or one or more output devices.

The term “merchant” shall refer to an entity who may offer to sell, lease, and/or license a product to a customer, for the customer or on behalf of another. For example, merchants may include various sales channels, individuals, companies, manufacturers, distributors, direct sellers, re-sellers, and/or retailers. Merchants may transact from buildings including stores, outlets, malls and warehouses, and/or they may transact via any number of additional methods including mail order catalogs, vending machines, online web sites, and/or telephone marketing. A manufacturer may choose not to sell to customers directly and in such a case, a retailer or another entity may serve as a sales channel for the manufacturer.

The term “merchant device” shall refer to a device that is capable of receiving instructions from a merchant and is capable of communicating instructions to a controller and/or to a benefit-dispensing device. The instructions may indicate, e.g., products to sell, pricing information, benefits, and forward commitment offers.

The term “output device” shall refer to a device that is used to output information. An output device may communicate with or be part of another device (e.g. a point of sale terminal, a point of display terminal, a user device, a merchant device, a benefit-dispensing device, a controller, etc.). An output device may include, e.g., a cathode ray tube (CRT) monitor, a liquid crystal display (LCD) screen, a light emitting diode (LED) screen, a printer, an audio speaker, an infra-red transmitter, a radio transmitter, an MP3 player, an iPod® or like playing device, a handheld gaming device, PlayStation Portable (by Sony Computer Entertainment Inc.

The term “player tracking card” shall refer to a device that is capable of storing information about a customer who is a casino player. This information may include information which identifies the casino player, as well as financial information involving the player (e.g., a number of remaining gambling credits which the player can redeem). The card may be machine readable (e.g., by a gaming device) in a known manner.

The terms “products,” “goods,” “merchandise,” and “services” shall be synonymous and shall each refer to anything licensed, leased, sold, available for sale, available for lease, available for licensing, and/or offered or presented for sale, lease, or licensing including packages of products, subscriptions to products, contracts, information, services, and intangibles.

The terms “product cost”, “item cost”, and “cost” shall be synonymous and shall each refer to the cost of a product to the operator or other seller of that product, typically in terms of one unit of the given product.

The terms “restock date” and “restock time” shall be synonymous and shall refer to the time and/or date that a vending machine is scheduled to be restocked or is actually restocked (e.g., by the vending machine's operator or the operator's agent).

The terms “sales machine”, “automatic sales machine”, “benefit-dispensing device” and “dispensing device” shall be synonymous and shall refer to any device capable of providing a benefit such as: dispensing money, dispensing a product of value, and/or performing a service of value. Dispensing devices may be of many different types including: gaming devices, vending machines (including, but not limited to, snack and/or beverage machines), automatic teller machines (ATM), ticket dispensers, kiosks, pay phones, telephones, cell phones, pagers, networked computers, wireless personal digital assistants (PDAs), point of sale (POS) terminals, gas pumps, washing machines, dryers, juke boxes, skill crane games, arcade games, game consoles, and audio/video players. A dispensing device may include hardware and software to support the operations in addition to the hardware and/or software used to perform the dispensing devices' conventional transaction processing and dispensing functions. Alternatively, a dispensing device may not include any hardware and/or software to support operations except to merely receive and respond to a signal from a controller directing the dispensing device to dispense a benefit.

The term “tangible value” and “tangible benefit” shall refer to items or services that are intrinsically valuable, such as cash, and therefore which may provide a sensation of instant gratification. Tangible value is distinct from “abstract value” such as an electronic funds transfer to a bank account. In other words, tangible value may be directly perceived with the five basic senses as opposed to only being intellectually comprehended. Coins dropping into a slot machine tray, cash dispensed by an ATM, and food or beverage dispensed from a vending machine are examples of tangible value, while credits or interest accumulating in an account are examples of abstract value.

The terms “user device”, “personal device”, “customer device”, and “customer device” shall be synonymous and shall refer to any device capable of transmitting data to and/or receiving data from another computer or device, such as a merchant device, a benefit-dispensing device, and/or a controller. User devices may be of many different types, including telephones, cell phones, pagers, laptops, networked computers, wireless personal digital assistants (PDAs), game consoles, audio/video players, kiosks, or any combination thereof.

The terms “vending machine operator”, and “operator” shall be synonymous and shall refer to the owner (or agent thereof) of a vending machine or the entity responsible for operating the vending machine.

### System

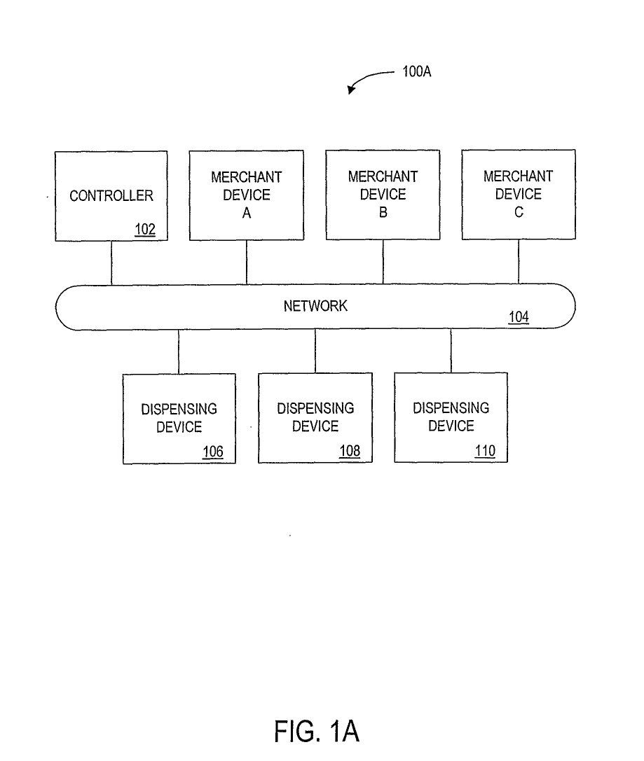

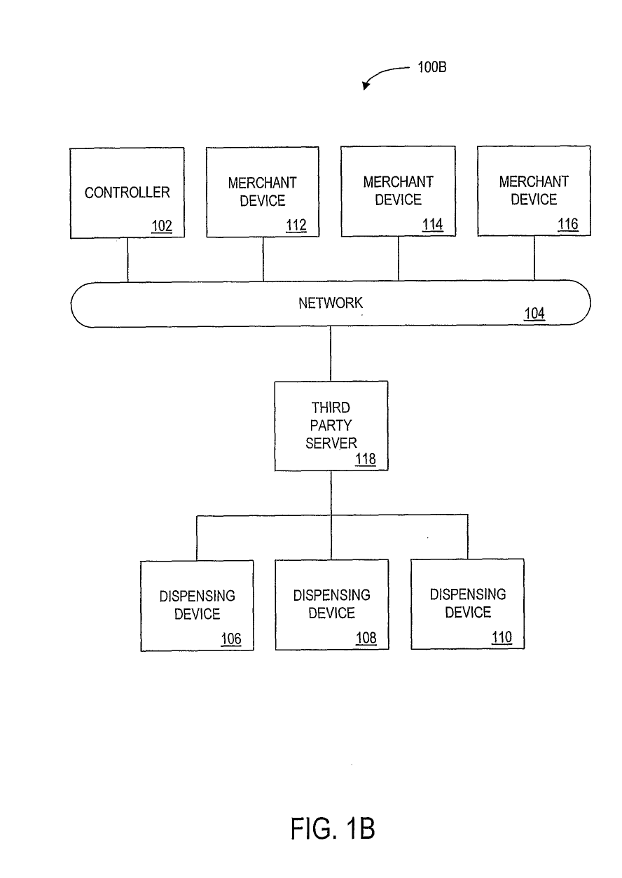

Referring now to FIG. 1A, a system 100A according to an embodiment includes a controller 102 that is in one or two-way communication via a communications network 104 (such as the Internet or other communications link) with one or more dispensing devices 106, 108, 110, and/or merchant devices 112, 114, 116. In one embodiment, the controller 102 is partially or wholly under the control of a merchant or other entity that may also control the dispensing devices 106, 108, 110. For example, the controller 102 may be a server in a bank's ATM network, a slot server in a casino's network of gaming devices, or a server in a network of vending machines. In some embodiments, a single apparatus (e.g., an appropriately programmed vending machine) performs the functionality of the controller and the dispensing device.

Referring to FIG. 1B, a system 100B according to an embodiment further includes one or more third party servers 118. A third-party server 118 may also be in one or two-way communication with the controller 102. However, as shown in the embodiment depicted in FIG. 1B, the third-party server 118 may be disposed “between” the controller 102 and the dispensing devices 106, 108, 110 such that communications from or to the dispensing devices 106, 108, 110 involve the third party server 118.

A difference between the two embodiments respectively depicted in FIGS. 1A and 1B is that the embodiment of FIG. 1B includes the third-party server 118, which may be operated by an entity that is both physically remote and distinct from the entity that operates the controller 102. The third party server 118 may perform various processes described herein by sending to the controller 102 signals to be relayed or otherwise communicated to the dispensing devices 106, 108, 110. For example, an airline company may operate a third party server 118 that communicates with a bank server (which performs functions of the controller 102) to provide customers with cash via ATMs (which perform functions of the dispensing devices 106, 108, 110) in exchange for committing to traveling with the airline. In the embodiment of FIG. 1A, the functions of the third-party server 118 of the embodiment of FIG. 1B are performed by the controller 102.

An additional difference between the two embodiments illustrated in FIGS. 1A and 1B relates to the communications topology of the systems. In the embodiments of FIGS. 1A and 1B, each node (i.e. each device that communicates) may communicate with every other node in the system 100, for example, via a virtual private network (VPN) or other known methodology for secure communication. Thus, all nodes may be “logically” connected in that any node may communicate with any other node directly or indirectly.

However, the embodiment depicted in FIG. 1B allows the third party server 118 to serve as a single “gateway” between (i) those nodes that would typically be operated by the owner/operator of the dispensing devices 106, 108, 110 (and the customers of the dispensing devices) and (ii) the other nodes in the system 100B which are typically not operated by the owner/operator of the dispensing devices (e.g., merchant devices operated by one or more merchants).

In some embodiments, a different merchant may control each of the merchant devices. The controller 102 may be operated by an entity that, e.g., delivers customers to the different merchants. If the system includes a third party server 118, that third party server 118 may be operated by an unrelated entity that merely permits the operators of the controller 102 to have access to customers who are operating the dispensing devices 106, 108, 110. Thus, in such an example embodiment, the system may involve one or more of the following: merchants (operating merchant devices 112, 114, 116), an agent responsible for customer acquisition and related services (operating the controller 102), third party network operators (operating third party servers 118), and customers (operating dispensing devices 106, 108, 110 to, e.g., purchase products). In an embodiment, a merchant may operate a combined controller/dispensing device directly, and the system may only involve a merchant and a customer.

In both embodiments illustrated in FIGS. 1A and 1B, communication between the nodes (e.g., the controller 102, the merchant devices 112, 114, 116, the dispensing devices 106, 108, 110, and/or the third party server 118) may be direct without a network and/or via a network such as the Internet 104.

Referring to both FIGS. 1A and 1B, each of the controller 102, the third party server 118, the merchant devices 112, 114, 116, and the dispensing devices 106, 108, 110 may comprise computers, such as those based on the Intel® Pentium® processor, that are adapted to communicate with each other. Any number of third party servers 118, merchant devices 112, 114, 116, and/or dispensing devices 106, 108, 110 may be in communication with the controller 102. In addition, the dispensing devices 106, 108, 110 may be in one or two-way communication with the merchant devices 112, 114, 116. The controller 102, the third-party server 118, the merchant devices 112, 114, 116, and the dispensing devices 106, 108, 110 may each be physically proximate to each other or geographically remote from each other. The controller 102, the third-party server 118, the merchant devices 112, 114, 116, and the dispensing devices 106, 108, 110 may each include input devices (not pictured) and output devices (not pictured).

As indicated above, communication between the controller 102, the third-party server 118, the merchant devices 112, 114, 116, and the dispensing devices 106, 108, 110 may be direct or indirect, such as over an Internet Protocol (IP) network such as the Internet 104, an intranet, or an extranet through a web site maintained by the controller 102 (and/or the third-party server 118) on a remote server or over an on-line data network including commercial on-line service providers, bulletin board systems, routers, gateways, and the like. In yet other embodiments, the devices may communicate with the controller 102 over local area networks including Ethernet, Token Ring, and the like, radio frequency communications, infrared communications, microwave communications, cable television systems, satellite links, Wide Area Networks (WAN), Asynchronous Transfer Mode (ATM) networks, Public Switched Telephone Network (PSTN), other wireless networks, and the like.

Those skilled in the art will understand that devices in communication with each other need not be continually transmitting to each other. On the contrary, such devices need only transmit to each other as necessary, and may actually refrain from exchanging data most of the time. For example, a device in communication with another device via the Internet 104 may not transmit data to the other device for weeks at a time.

The controller 102 (and/or the third-party server 118) may function as a “web server” that presents and/or generates web pages which are documents stored on Internet-connected computers accessible via the World Wide Web using protocols such as, e.g., the hyper-text transfer protocol (“HTTP”). Such documents typically include one or more hyper-text markup language (“HTML”) files, associated graphics, and script files. A web server allows communication with the controller 102 in a manner known in the art. The merchant devices 112, 114, 116 and the dispensing devices 106, 108, 110 may use a web browser, such as NAVIGATOR® published by NETSCAPE® for accessing HTML forms generated or maintained by or on behalf of the controller 102 and/or the third-party server 118.

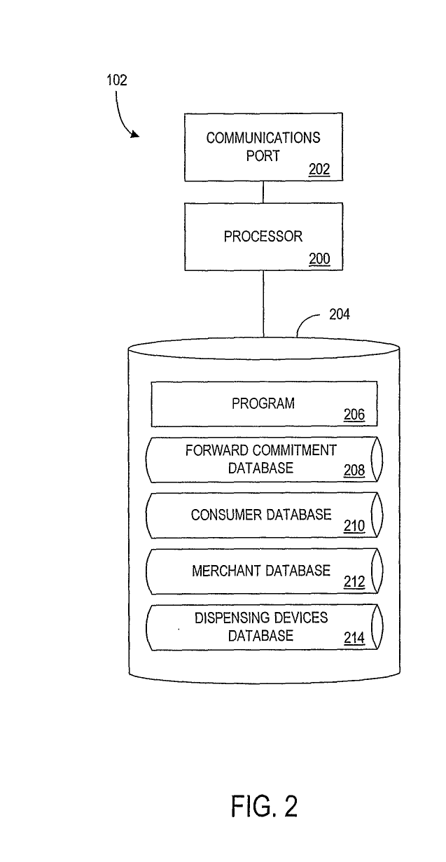

As indicated above, any or all of the controller 102, the third-party server 118, the merchant devices 112, 114, 116 and the dispensing devices 106, 108, 110 may include, e.g., processor-based cash registers, telephones, interactive voice response (IVR) systems such as the ML400-IVR designed by MISSING LINK INTERACTIVE VOICE RESPONSE SYSTEMS, cellular/wireless phones, vending machines, pagers, personal computers, portable types of computers, such as a laptop computer, a wearable computer, a palm-top computer, a hand-held computer, and/or a Personal Digital Assistant (“PDA”). Further details of each of the controller 102, the third-party server 118, the merchant devices 112, 114, 116 and the dispensing devices 106, 108, 110 are provided below with respect to FIGS. 2 through 4.

As described above, in some embodiments a single device may include the functionality of the controller 102, the third-party server 118, merchant devices 112, 114, 116, and/or dispensing devices 106, 108, 110. For example, the controller may include some or all of the functionality of a merchant device, and/or the third-party server may include some or all of the functionality of a dispensing device. Further, the controller 102 may communicate with merchants directly instead of through the merchant devices 112, 114, 116. Similarly, the controller 102 may communicate with customers directly, instead of through the dispensing devices 106, 108, 110. For example, a customer may communicate directly with a controller 102 via a user device, such as a cellular telephone or PDA.

Although not illustrated in FIGS. 1A and 1B, the controller 102, the third-party server 118, the merchant devices 112, 114, 116, and the dispensing devices 106, 108, 110 may also be in communication with one or more banking or credit institutions (e.g., customer and/or merchant credit institutions), and may communicate with such institutions in a known manner to effect transactions (e.g., process transactions paid for with credit card accounts, transfer funds to payees). Communication with such institutions may be performed in any of a number of known manners, such as directly or via a secure financial network, such as the Fedwire network maintained by the United States Federal Reserve System, the Automated Clearing House (hereinafter “ACH”) Network, the Clearing House Interbank Payments System (hereinafter “CHIPS”), or the like.

The merchant devices 112, 114, 116 and/or the dispensing devices 106, 108, 110 may communicate to provide/receive information (e.g., information about the customer and/or the forward commitment agreement) via the controller 102. In embodiments that include a third-party server 118 or the like, such information may be provided/received by the merchant devices 112, 114, 116 and/or the dispensing devices 106, 108, 110 via the third-party server 118. The merchant devices 112, 114, 116 may for example, provide information (e.g., rules related to offering benefits) to the controller 102 (and/or the third-party server 118). The dispensing devices 106, 108, 110 may provide customer obligation information to the controller 102 (and/or the third-party server 118). The controller 102 (and/or the third-party server 118) may provide information about executed forward commitment agreements to the merchant devices 112, 114, 116 and/or may provide control signals to one or more of the dispensing devices 106, 108, 110 directing the dispensing device to provide benefits to customers.

### Devices

FIG. 2 illustrates details of an example of the controller 102 of FIG. 1A (and/or the third-party server 118 of FIG. 1B). According to an embodiment, the controller 102 is operative to manage the system and execute various methods described herein. The controller 102 may be implemented as one or more system controllers, one or more dedicated hardware circuits, one or more appropriately programmed general purpose computers, or any other similar electronic, mechanical, electromechanical, and/or human operated device. For example, in FIG. 1B, the controller 102 is depicted as in communication with a third-party server 118. In the embodiment of FIG. 1B, the controller 102 and the third-party server 118 could, in an embodiment, provide the same functionality as the controller 102 alone provides in the embodiment of FIG. 1A.

The controller 102 (and/or the third-party server 118) may include a processor 200, such as one or more Intel® Pentium® processors. The processor 200 may include or be in communication with one or more clocks or timers (not pictured), which may be useful for determining information relating to time, such as whether a forward commitment has been fulfilled within a specified time. The processor 200 may include or be in communication with one or more communication ports 202 through which the processor 200 communicates with other devices such as the merchant devices 112, 114, 116, the dispensing devices 106, 108, 110 and/or the third-party server 118 in a known manner.

The processor 200 may also be in communication with a data storage device 204. The data storage device 204 includes an appropriate combination of magnetic, optical and/or semiconductor memory, and may include, for example, additional processors, communication ports, Random Access Memory (“RAM”), Read-Only Memory (“ROM”), a compact disc and/or a hard disk. The processor 200 and the storage device 204 may each be, for example: (i) located entirely within a single computer or other computing device; or (ii) connected to each other by a remote communication medium, such as a serial port cable, a LAN, a telephone line, radio frequency transceiver, a fiber optic connection or the like. In some embodiments, for example, the controller 102 may comprise one or more computers (or processors 200) that are connected to a remote server that is operative to maintain databases, where the data storage device 204 comprises the combination of the remote server computer and the associated databases.

The data storage device 204 stores a program 206 for controlling the processor 200. The processor 200 performs instructions of the program 206, and thereby operates in accordance with various embodiments, and particularly in accordance with various methods described herein.

Embodiments can be include a computer program developed using, e.g., an object oriented language that allows the modeling of complex systems with modular objects to create abstractions that are representative of real world, physical objects and their interrelationships. However, it would be understood by one of ordinary skill in the art that embodiments can be implemented in many different ways using a wide range of programming techniques as well as general purpose hardware systems or dedicated controllers.

The program 206 may be stored in a compressed, uncompiled and/or encrypted format. The program 206 furthermore may include program elements that may be generally useful, such as an operating system, a database management system and “device drivers” for allowing the processor 200 to interface with computer peripheral devices. Appropriate general purpose program elements are known to those skilled in the art.

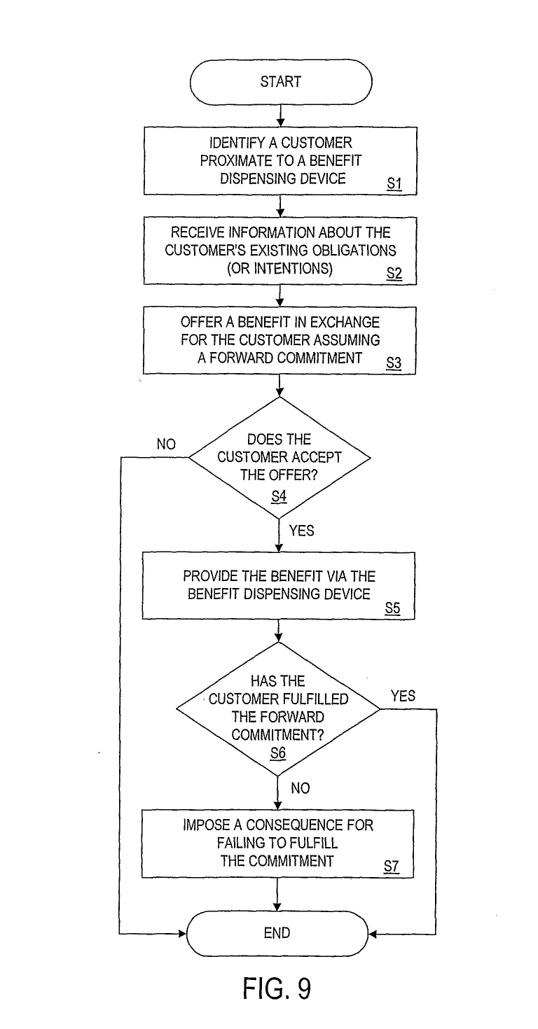

Further, the program 206 may include instructions which direct the processor to execute any of a number of modules, subroutines, programs, etc. that have particular relevance to embodiments described herein. Such modules may direct the processor to perform any or all of the following: (i) identify a customer as a potential candidate to be offered a forward commitment agreement through a user device and/or through a dispensing device 106, 108, 110; (ii) receive information about a customer; one or more routines to offer a benefit to a customer; (iii) determine if a customer accepts a forward commitment offer; (iv) signal dispensing devices 106, 108, 110 to dispense a benefit upon a customer's assumption of a forward commitment; (v) verify a customer's fulfillment of the forward commitment; (vi) impose a consequence upon a customer who fails to fulfill a commitment; (vii) facilitate and control communications between devices, such as between merchant devices, dispensing devices, the controller, and/or a third party server; and (viii) control databases or software objects that track information regarding customers, merchants, third parties, dispensing devices, inventory, benefits, forward commitments, and/or fulfillment. Examples of such routines and their operation are described in detail herein, and particularly in conjunction with FIG. 9.

According to an embodiment, the instructions of the program 206 may be processed in a known manner. For example, the instructions can be read into a main memory (e.g., a RAM) of the processor 200 from another computer-readable medium (e.g., from a ROM or hard drive). Execution of the instructions causes processor 200 to perform the process the steps of the process the instructions define, such as the processed described herein. In alternative embodiments, hard-wired circuitry or integrated circuits may be used in place of, or in combination with, software instructions which define the processes. Thus, the present invention is not limited to any specific combination of hardware, firmware, and/or software.

Continuing with the embodiment of FIG. 2, the storage device 204 is also operative to store (i) a forward commitment database 208, (ii) a customer database 210, (iii) a merchant database 212, and (iv) a dispensing devices database 214. The databases 208, 210, 212, 214 are described in detail below and example structures are depicted with sample entries in the accompanying figures. As will be understood by one of ordinary skill in the art, the schematic illustrations and accompanying descriptions of the sample databases presented herein are exemplary arrangements for stored representations of information. Any number of other arrangements may be employed besides those suggested by the tables shown. For example, even though four separate databases are illustrated, various embodiments could be practiced effectively using one, two, three, five, six, or more functionally equivalent databases. Similarly, the illustrated entries of the databases represent exemplary information only; one of ordinary skill in the art will understand that the number and content of the entries can be very different from those illustrated herein. Further, despite the depiction of the databases as tables, an object-based model or other known models could be used to store and manipulate the data and data types described herein. Likewise, object methods or behaviors can be used to implement the processes described herein.

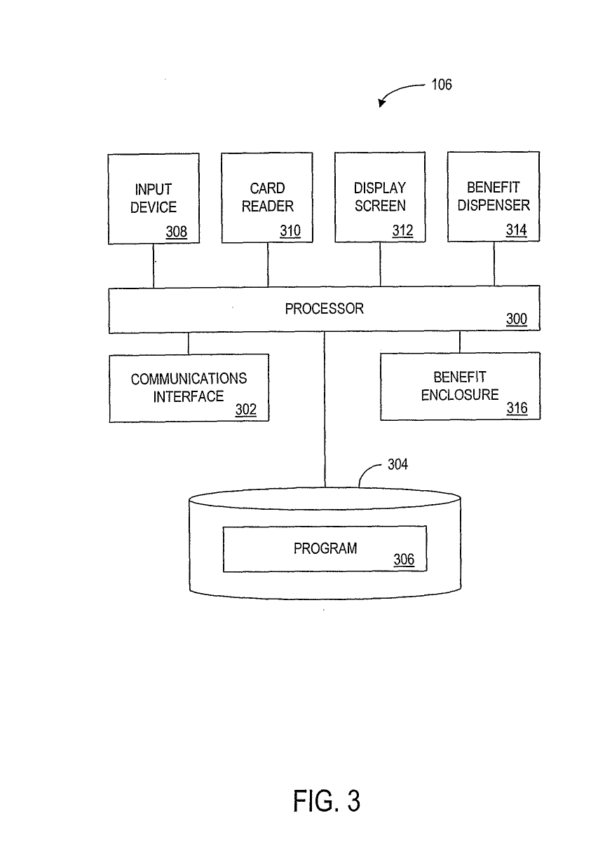

FIG. 3 illustrates an example dispensing device 106. A dispensing device 106 may include a processor 300 coupled to a communications interface 302, a data storage device 304 that stores a dispensing device program 306, an input device 308, a card reader device 310, a display screen 312, and a benefit dispenser 314. A dispensing device program 306 may include instructions which, when performed by the processor, facilitate and control communications and interaction with the controller 102, and/or create and control a user interface to facilitate communications and interaction with a customer.

In addition, a dispensing device 106 may include additional devices to support other functions. For example, an ATM functioning as a dispensing device 106 may include (i) a known type of apparatus that is operable to receive, count, and dispense cash, (ii) a known type of printing device that is operable to generate a receipt, and/or (iii) a known type of security camera. In another example, a gaming device functioning as a dispensing device 106 may include (i) a known apparatus that is operable to generate and/or sell outcomes that are certified by a gaming authority. Such a known apparatus may include, e.g., a slot machine such as a conventional reel slot machine, a video slot machine, a video poker machine, a video keno machine, a video blackjack machine, and/or another type of gaming machine. In yet another example, a gasoline pump functioning as a dispensing device 106 may include (i) a known type of apparatus that is operable to pump, measure, and manage the flow of fuel from a storage container. Further, many alternative input and output devices may be used in place of the various devices illustrated in FIG. 3. Uses of these dispensing device 106 components are discussed below.

In one embodiment, one or more of a benefit-dispensing device 106, 108, 110, a controller 102, and/or a merchant device 112, 114, 116, comprise a vending machine. Generally, a vending machine according to an embodiment can include a device configured to manage sales transactions with customers by, among other things, receiving payment from customers; controlling the pricing, dispensing and/or distribution of goods; and/or controlling entitlements to services.

In some embodiments, suitable cabinetry for a vending machine may be constructed from any suitable material in a known manner, including but not limited to any combination of (1) commercial grade steel (e.g. for exterior panels and internal shelving), (2) transparent materials such as glass or Plexiglas (e.g. for item display windows), (3) rubber (e.g. for waterproofing insulation), (4) plastic, and/or (5) aluminum. Many commercially available vending machine casings can be adapted to work in accordance with various embodiments. For example, in snack machine embodiments, a suitable machine casing may comprise the 129 SnackShop manufactured by Automatic Products International, Ltd. of Saint Paul, Minn., which stands at 72″/1829 mm wide, has a width of 38⅞″/988 mm, and a depth of 35″/889 mm. Other suitable snack machine casings include the A La Carte® machine from Automatic Products, and the GPL SnackVendor model # 159 from Crane Merchandising Systems/Crane Co. of Stamford, Conn.

In embodiments in which vending machine comprise beverage vending machines, machine casings commercially available from Dixie Narco, Inc. of Williston, S.C. may be employed. Beverage machine casings may comprise a “cooler” or “glass front” style front panel, featuring a transparent front panel (e.g. glass) enabling customers to see inventory for sale. Alternatively, beverage machine casings may comprise a “bubble front” style front panel, featuring a decorative front panel, typically used to advertise a logo of a product manufacturer commercially interested in the vending machine's operation.

Various other vending machine embodiments are contemplated as well, including combination snack and beverage vending machine embodiments, such as those available from Crain Co. Further details concerning the suitability of machine casing/cabinetry are well known in the art.

As is well known, inventory storage and distribution functions of a vending machine configured in accordance with a snack machine embodiment may include one or more of: (I) a drive motor, (ii) metal shelves, (iii) a product delivery system (e.g. a chute, product tray, product tray door, etc.), (iv) dual spiral (i.e. double helix) item dispensing rods, (v) convertible (i.e. extendable) shelves, and/or (vi) a refrigeration unit. In embodiments using the casing of the model 129 SnackShop manufactured by Automatic Products, three removable shelves may be employed, together providing for 30 product rows and an inventory capacity of between 185 to 522 commonly vended snack products. Inventory storage and distribution functions of a vending machine configured in accordance with a beverage machine embodiment may include one or more of: (i) metal and/or plastic shelving, (ii) item dispensing actuators/motors, (iii) product delivery chutes, and/or (iv) a refrigeration unit. Further details concerning vending machine inventory storage and dispensing mechanisms are well known in the art, and need not be described in further detail herein.

In some embodiments, a vending machine may also include one or more known mechanisms for receiving payment and dispensing change, such as a coin acceptor, a bill validator, a card reader (e.g. a magnetic stripe reader) and a change dispenser. In a well known manner, a magnetic stripe card reader may read data on the magnetic stripe of a credit or debit card, and it may cooperate with conventional point-of-sale credit card processing equipment to validate card-based purchases through a conventional transaction authorization network. Suitable card-based transaction processing systems and methods are available from, e.g., USA Technologies, Inc.

The coin acceptor, bill validator and change dispenser may communicate with a currency storage apparatus (a “hopper”) and may comprise conventional devices such as models AE-2400, MC5000, TRC200 by Mars, Inc. of West Chester, Pa., or CoinCo model 9300-L. The coin acceptor and bill validator may receive and validate currency that is stored by the currency storage apparatus. The change dispenser activates the return of coinage from the currency storage apparatus to the customer where appropriate (e.g. where a customer deposits more currency than is required for a given transaction). Such apparatus may feature Multidrop Bus (MDB) and/or Micromech peripheral capabilities, as is well known.

In another embodiment, a vending machine may be configured to receive payment authorization and product selection commands through a wireless device communication network, directly or indirectly, from a customer's wireless device (e.g. a cellular telephone). In such an embodiment, a payment processing mechanism may comprise a cellular transceiver operatively connected to a processor, as described herein. Systems and methods allowing for the selection of and payment for vending machine articles through cellular telephones are provided by USA Technologies, Inc., of Wayne, Pa. Further, in such an embodiment, a cellular telephone may serve as an input/output device, as described herein. Further details concerning vending machine payment processing mechanisms are well known in the art.

In some embodiments, a vending machine may include an input device for receiving input from (i) a customer indicating a product and/or offer selection, and/or (ii) an operator (or agent thereof) of the vending machine, such as typically occurs during stocking or maintenance of the vending machine. Also, a vending machine may include one or more output devices for outputting product or offer information to a customer or operator. Many combinations of input and output devices may be employed. In some embodiments, a vending machine may include more than one input device. For example, vending machine may include an exterior input device for receiving customer input and an interior input device for receiving operator input. In some embodiments, however, the input device provides the dual functionality of receiving input data from both operators and customers. Likewise, a vending machine may comprise more than one output device (e.g. an LCD screen and several LEDs, as described herein). However, in some embodiments, such as those which feature touch screens (described herein), input and output functionality may be provided by a single device.

Many types of input devices are contemplated. Thus, an input device may comprise one or more of (1) a set of alpha-numeric keys for providing input to the vending machine, such as the Programmable Master Menu® Keypad, (2) a selector dial, (3) a set of buttons associated with a respective set of item dispensers, (4) a motion sensor, (5) a barcode reader, (6) a voice recognition module, (7) a Dual-Tone Multi-Frequency receiver/decoder, (8) a wireless device (e.g. a cellular telephone or wireless Personal Digital Assistant), and/or (9) any other conventional input device commonly employed by a vending machine designer.

Likewise, many types of output devices are contemplated. For example, an output device may comprise a Liquid Crystal Display (LCD). Alternatively or additionally, an output device may also comprise one or more Light Emitting Diode (LED) displays (e.g. several alphanumeric multi-color or single color LED displays on the shelves of a vending machine associated proximately with each row of product inventory).

In one embodiment, an LED display screen is mounted atop the vending machine (via bolts or other mounting hardware) and is used to communicate offers and other messages (e.g. product advertisements) to prospective customers. A suitable LED display screen for such an embodiment may be housed in an aluminum case having a length of 27.5″, a height of 4.25″, and a depth of 1.75″. Such a display screen may have a display area capable of showing 13 alphanumeric and/or graphical characters. Further, such an LED display screen may comprise a serial computer interface, such as an RJ45/RS232 connector, for communicating with a processor, as described herein. Further still, such an LED display may be capable of outputting text and graphics in several colors (e.g. red, yellow, green, black) regarding current and upcoming promotions.

Further, in some embodiments, an output device comprises a printer. In one embodiment, a printer is configured to print on card stock paper (e.g. 0.06 mm to 0.15 mm thickness), such as the EPSON EU-T400 Series Kiosk Printer. Further, a printer may be capable of thermal line printing of various alphanumeric and graphical symbols in various font sizes (e.g. ranging from 9 to 24 point) on various types of paper. Additionally, such a printer may communicate with a processor (described herein) via an RS232/IEEE 12834 and/or bi-directional parallel connection. Such a printer may further comprise a 4 KB data buffer.

Additionally, in some embodiments, an output device comprises an audio module, such as an audio speaker, that outputs information to customers audibly.

As stated, in some embodiments, a touch-sensitive screen may be employed to perform both input and output functions. Suitable, commercially available touch screens for use in accordance with various embodiments are manufactured by Elo TouchSystems, Inc., of Fremont, Calif., such as Elo's AccuTouch series touch screens. Such touch screens may comprise: (i) a first (e.g. outer-most) hard-surface screen layer coated with an anti-glare finish, (ii) a second screen layer coated with a transparent-conductive coating, (iii) a third screen layer comprising a glass substrate with a uniform-conductive coating. Further, such touch screens may be configured to detect input within a determined positional accuracy, such as a standard deviation of error less than ±0.080-inch (2 mm). The sensitivity resolution of such touch screens may be more than 100,000 touchpoints/in² (15,500 touchpoints/cm) for a 13-inch touch screen. For such touch screens, the touch activation force required to trigger an input signal to the processor (described herein) via the touch screen is typically 2 to 4 ounces (57 to 113 g). Additionally, touch screens for use in accordance with various embodiments may be resistant to environmental stressors such as water, humidity, chemicals, electrostatic energy, and the like. These and other operational details of touch screens (e.g. drive current, signal current, capacitance, open circuit resistance, closed circuit resistance, etc.) are well known in the art and need not be described further herein.

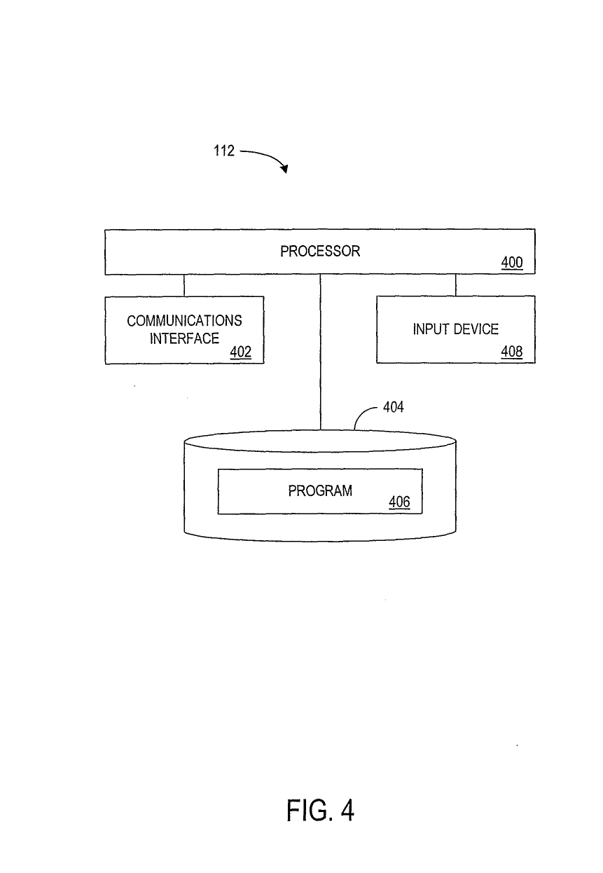

FIG. 4 illustrates an example merchant device 112. A merchant device 112 may include a processor 400 coupled to a communications port 402, a data storage device 404 that stores a merchant device program 406, and an input device 408. A merchant device program 406 may include one or more routines to facilitate and control communications and interaction with the controller 102 as well as a user interface to facilitate communications and interaction with a merchant or a merchant's computing systems. A merchant device may be implemented by any number of devices such as, for example, a processor based cash register, a telephone, an IVR system, a cellular/wireless phone, a vending machine, a pager, a personal computer, a portable computer such as a laptop, a wearable computer, a palm-top computer, a hand-held computer, a PDA, and/or a device that combines any or all functions of these devices, such as, for example, the Treo® by Handspring®.

### Databases

Although the example embodiment of FIG. 2 is illustrated to include four particular databases stored in storage device 204, other database arrangements may be used. In other words, various embodiments could be implemented using any number of different database files or data structures, as opposed to the four particular databases depicted in FIG. 2. Further, the individual database files could be stored on a plurality of servers (e.g. located on different storage devices in different geographic locations, such as on a third-party server 118). Likewise, the program 206 could also be located remotely from the storage device 204 and/or on another server. As indicated above, the program 206 according to an embodiment includes instructions for retrieving, manipulating, and storing data in the databases 208, 210, 212, 214 as necessary to perform various methods.

1. Forward Commitment Database

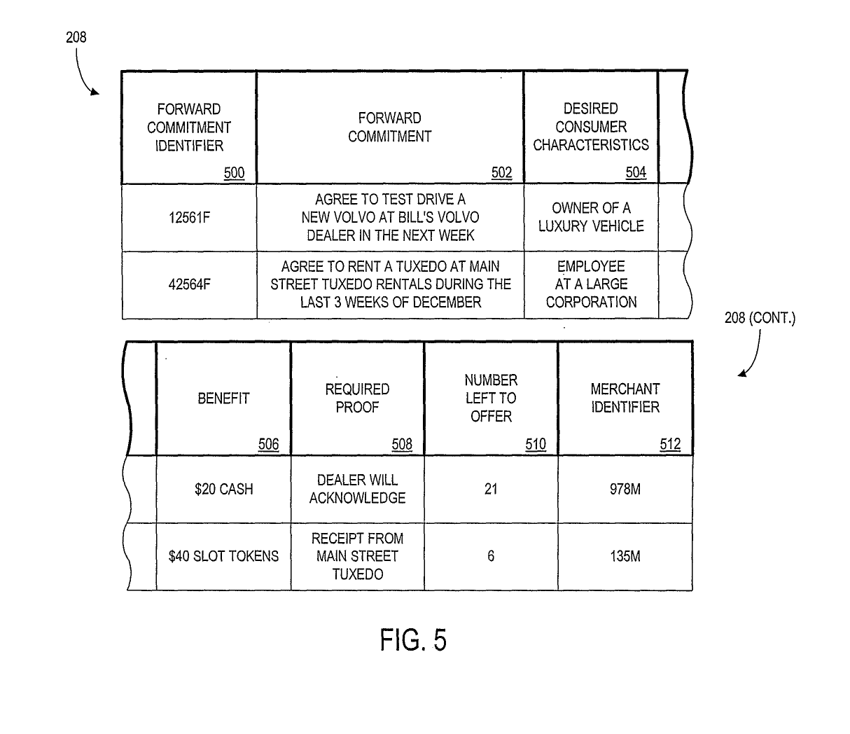

Turning to FIG. 5, a tabular representation of an embodiment of a forward commitment database 208 according to some embodiments is illustrated. This particular tabular representation of a forward commitment database 208 includes sample records or entries, each of which includes information regarding a particular forward commitment agreement or particular type of particular forward commitment agreement. Such a forward commitment database 208 may include any number of entries. In some embodiments, a forward commitment database 208 is used to record/track/analyze things, such as forward commitments, characteristics of target customers or desired customers, benefits, and requirements for fulfilling the forward commitment.

The particular tabular representation of a forward commitment database 208 depicted in FIG. 5 defines a number of fields for each of the entries or records. The fields may include: (i) a forward commitment identifier field 500 that stores a representation (e.g., an sequence of alphanumeric characters) that uniquely identifies the forward commitment agreement; (ii) a forward commitment field 502 that stores a representation of a description of the forward commitment associated with the commitment agreement; (iii) a desired customer characteristics field 504 that stores a representation of a description of the characteristics the merchant desires in a customer; (iv) a benefit field 506 that stores a representation of a description of a benefit associated with the commitment agreement; (v) a required proof field 508 that stores a representation of a description of what is required to prove that the forward commitment has been fulfilled; (vi) a “number left to offer” field 510 that stores a representation of the number of forward commitment agreements remaining that the merchant is willing to offer; and (vii) a merchant identifier field 512 that stores a representation uniquely identifying the merchant offering the forward commitment agreement.

The example forward commitment database 208 depicted in FIG. 5 provides example data to illustrate the meaning of the information stored in this database embodiment. A forward commitment identifier 500 (e.g. “12561F”, “42564F”) may be used to identify and index the forward commitment agreements defined by the entries of the forward commitment database 208. Two examples of forward commitments are defined by the two illustrated entries, and are described by the respective data corresponding to each entry's respective forward commitment field 502. The first description, “Agree to test drive a new Volvo at Bill's Volvo Dealer in the next week,” is an example of a forward commitment to sample a product. The second description, “Agree to rent a tuxedo at Main Street Tuxedo Rental during the last three weeks of December,” is an example of a forward commitment to rent a product. Both example entries illustrated in FIG. 5 include a time period requirement (i.e. “in the next week”, “during the last 3 weeks of December”). Thus, in either case, if the commitment is not fulfilled by a certain date, the controller or another device may determine that the customer has breached the forward commitment agreement and may impose a consequence. The desired customer characteristics field 504 indicates examples of the type of customer the merchant desires to reach and the benefit field 506 indicates how much the merchant is will to spend to do so (e.g., on a per-customer basis).

In the first sample entry, the merchant (Bill's Volvo Dealer, merchant identifier 512 “978M”) offering the first-listed forward commitment agreement has determined that it is worth $20.00 to have an “owner of a luxury vehicle” test drive a new Volvo. The required proof field 508 indicates that Bill's Volvo Dealership will acknowledge to the system 100 if and/or when the customer has fulfilled the forward commitment. The “number left to offer” field 510 indicates that Bill's Volvo Dealership is willing to offer this forward commitment agreement to twenty-one additional owners of luxury vehicles. On the other hand, a merchant might have no such limit, or might have a limit that is determined based on other information (e.g., calculated based in part on acceptance rates of past offers).

In the second sample entry illustrated in FIG. 5, the merchant (Main Street Tuxedo Rental, merchant identifier 512 “135M”) offering the second-listed forward commitment agreement has determined that it is worth $40.00 in slot tokens to have an “employee at a large corporation” rent a tuxedo towards the end of December. The required proof field 508 indicates that a receipt from Main Street Tuxedo Rental will be required to prove to the system 100 that the customer fulfilled the forward commitment. The “number left to offer” field 510 indicates that Main Street Tuxedo Rental is willing to offer this forward commitment agreement to six additional employees at large corporations. In an alternative embodiment, in place of or in addition to a “number left to offer” field 510, a “budget” field may be used that tracks an amount of money that remains to be spent (in terms of promotional or marketing dollars) on the particular forward commitment agreement. The merchant may define a cost per forward commitment agreement to use such a budget field.

In an alternate embodiment, a Forward Commitment Database may store separate records for each offer that may potentially be output to a customer. Thus, each separate record may be denoted by a unique forward commitment identifier, and each record may have a “number left to offer” of one. Such an embodiment may be useful in an embodiment where customers receive and accept forward commitment offers through user devices which communicate with a merchant device 112, 114, 116 and/or controller 102, as such customers may receive, upon acceptance of a forward commitment offer, a corresponding forward commitment identifier. Upon issuance of the forward commitment identifier, the merchant device 112, 114, 116 and/or controller 112 may set the “number left to offer” to one for the corresponding record, and the customer may present the forward commitment identifier to a benefit-dispensing device, such as a vending machine.

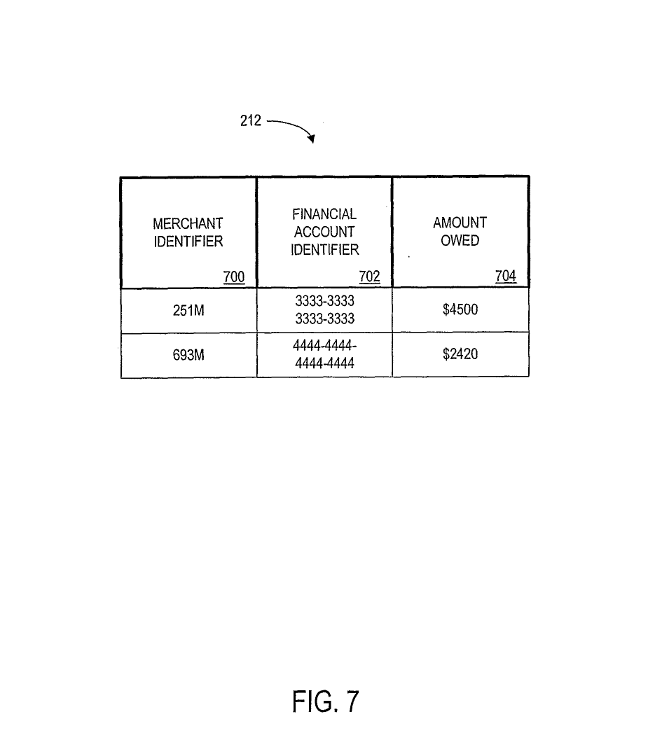

The benefit-dispensing device may, in turn, determine whether or not the presented forward commitment identifier is valid by querying a local or remote database, and/or by submitting an authorization query to a merchant device 112, 114, 116 and/or controller 112. After validating the forward commitment identifier, the benefit-dispensing device may permit the dispensing of a benefit, such as a soda from a beverage machine or snack item from a snack machine. Further, after the benefit has been redeemed from the benefit-dispensing device, a benefit-dispensing device 106, 108, 110, controller 112 and/or a merchant device 112, 114, 116 may update a merchant database (see, e.g., FIG. 7) to reflect the benefit dispensed through the benefit-dispensing device, and the amount owed to the operator of the benefit-dispensing device by the merchant.

2. Customer Database

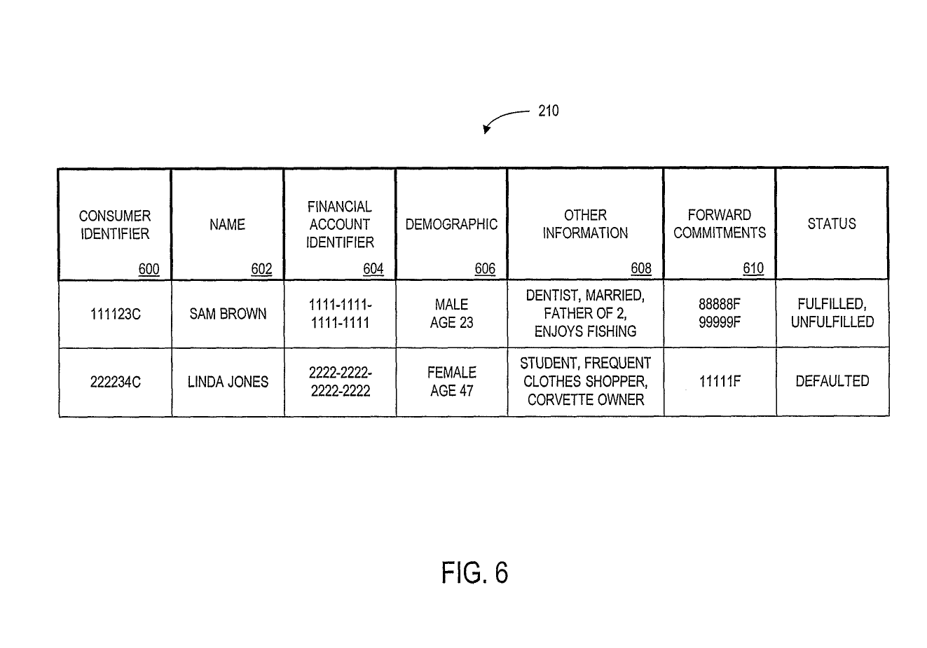

FIG. 6 depicts a tabular representation of an embodiment of customer database 210. This particular tabular representation of a customer database 210 includes two sample records or entries which each include information regarding a particular customer. In some embodiments, a customer database 210 is used to track customer information such as the customer's name, financial account information, demographic description, forward commitment agreements accepted and their fulfillment status. A customer database 210 may include any number of entries.

The particular tabular representation of a customer database 210 depicted in FIG. 6 defines a number of fields for each of the entries or records. The fields may include: (i) a customer identifier field 600 that stores a representation uniquely identifying a particular customer; (ii) a name field 602 that stores a representation of the customer's name; (iii) a financial account identifier field 604 that stores a representation of a bank account number, credit card account number, or other financial account identifier, which identifies a financial account which may be charged if the customer defaults on (e.g., fails to fulfill within a required time period) the commitment agreement; (iv) a demographic field 606 that stores a representation of a description of demographic characteristics of the customer for identifying customers with desired characteristics to whom forward commitment agreements may be offered; (v) an “other information” field 608 that stores a representation of a description of additional information about the customer (also for identifying customers with desired characteristics to whom forward commitment agreements may be offered); (vi) a forward commitments field 610 that stores a representation of the forward commitment agreements that the customer has entered into in the form of forward commitment identifiers 500; and (vii) a status field 612 that stores a representation of the current state of fulfillment (fulfilled, unfulfilled, or defaulted) of the commitment.

The financial account identifier field 604 may identify various types of financial accounts besides an account from which currency or money may be provided. For example, the financial account identifier field 604 may identify an account that defines a number of units of products that may be dispensed (e.g., free of charge) and/or redeemed. Debiting or crediting such an account could include increasing or decreasing the number of units, altering the types of products, altering when products may be dispensed/redeemed. Such an account may allow a customer to, e.g., redeem units of products over time as part of a “subscription” to vending machine products. Systems and methods for establishing and managing subscriptions to items sold at vending machines are disclosed in the following, each of which is incorporated herein by reference: (a) U.S. Pat. No. 6,298,972, entitled METHOD AND APPARATUS FOR ESTABLISHING AND MANAGING VENDING MACHINE SUBSCRIPTIONS, issued Oct. 9, 2001; (b) U.S. Pat. No. 6,085,888, entitled METHOD AND APPARATUS FOR ESTABLISHING AND MANAGING VENDING MACHINE SUBSCRIPTIONS, issued Jul. 11, 2000; (c) U.S. Pat. No. 5,988,346, entitled METHOD AND APPARATUS FOR ESTABLISHING AND MANAGING VENDING MACHINE SUBSCRIPTIONS, issued Nov. 23, 1999, and (d) PCT Application Serial No. US2004/041561, entitled PRODUCTS AND PROCESSES FOR ESTABLISHING MULTI-TRANSACTION RELATIONSHIPS WITH CUSTOMERS OF VENDING MACHINES filed Dec. 9, 2004.

The example customer database 210 of FIG. 6 provides example data to illustrate the meaning of the information stored in this database embodiment. A customer identifier 600 (i.e. 111123C, 222234C) may be used to identify and index customers who have entered into a forward commitment agreement.

In one embodiment, a customer identifier comprises or defines contact information of the customer, such as a telephone number (e.g., of a customer's cellular telephone). Thus, in an embodiment in which a customer receives and accepts forward commitment offers through a user device such as a cellular telephone, the customer's phone number may be recorded and referred to later, for example, to determine if the customer should not receive another forward commitment based on the customer's fulfillment status as indicated by status field 612. For example, a customer may use his cell phone to call a phone number that is associated with (e.g., a phone number which receives calls that are directed to or receivable by) the controller, a benefit-dispensing device, and/or a merchant device, in an attempt to receive and/or accept a forward commitment offer. If the controller, a benefit-dispensing device, and/or a merchant device determines, based on the customer's phone number and whether an appropriate call has been received via that phone number, that the customer has not fulfilled a previously accepted forward commitment offer, the customer may not be provided with one or more additional forward commitment offers.

In one embodiment, a customer identifier comprises information that defines a fingerprint, information that is derived from scanning a fingerprint, and/or information that may be determined to “match” a fingerprint (even if it may also match additional fingerprints). For example, the customer identifier can include information that defines

For example, the customer identifier can include data received from a fingerprint reader that has (1) scanned a fingerprint from a finger of the customer and (2) generated data which represents the fingerprint (although such data need not necessarily uniquely identify the fingerprint). Such a fingerprint reader may be an input device of a vending machine, and may scan a fingerprint, e.g., during a process in which a customer registers to be subsequently identified.

Subsequently, when a fingerprint reader is used to identify a customer, the fingerprint reader can scan a fingerprint from a finger of that customer, generate data which represents that fingerprint, and determine whether that data matches any stored fingerprint data (e.g., stored customer identifiers).

In one embodiment, a suitable fingerprint reader includes the Fujitsu MBF200 Scanner, which is manufactured by Tacoma Technology, Inc of Taipai, Taiwan and Fujitsu Microelectronics America, Inc. of Tokyo, Japan. The Fujitsu MBF200 offers a resolution of 500 dpi, an image capture area of 12.8×15 mm (0.5″×0.6″), and a unit size of 60×40×15 mm (2.4″×1.6″×0.6″). The Fujitsu MBF200 may communicate with a processor (e.g., of a vending machine) through an interface such as a USB interface. The Fujitsu MBF200 may be desirable in an embodiment where the vending machine is instructed through a Linux-based operating system. Known fingerprint matching software may be employed in embodiments featuring the Fujitsu MBF200. Exemplary fingerprint matching software includes VeriFinger 4.2 from Neurotechnologija, Ltd. of Vilnius, Lithuania.

Another suitable fingerprint reader for use with the present invention includes the AF-S2 FingerLoc from AuthenTec, Inc. of Melbourne, Fla. The AF-S2 FingerLoc offers a resolution of 250 dpi, an image capture area of 13×13 mm (0.51″×0.51″), and a unit size of 24×24×3.5 mm (0.94″×0.94″×0.14″). The AF-S2 FingerLoc may communicate with a vending machine processor through an interface such as a USB interface. The Fujitsu MBF200 may be desirable in an embodiment where the vending machine is instructed through a Microsoft® Windows®-based operating system. In embodiments featuring the AF-S2 FingerLoc, fingerprint matching software such as VeriFinger 4.2 may be employed.

In one embodiment, a customer identifier comprises other biometric information, such as information related to retinal patterns or voice prints. Similarly, appropriate input devices (e.g., retinal scanners, microphones) and appropriate software would facilitate using such biometric information (solely or partially) as customer identifiers.

The first sample entry describes a customer named “Sam Brown,” who has a credit card account number “1111-1111-1111-1111,” and is “male, age 33.” He is a “dentist, married, father of 2, [and] enjoys fishing.” According to the forward commitments field 610 and the status field 612, Sam Brown has entered into two forward commitment agreements “88888F” and “99999F” of which he has fulfilled the first and not yet fulfilled the second.

The second sample entry describes a customer named “Linda Jones,” who has a credit card account number “2222-2222-2222-2222,” and is “female, age 47.” She is a “student, frequent clothes shopper, [and a] Corvette owner.” According to the forward commitments field 610 and the status field 612, Linda Jones has entered into one forward commitment agreement “11111F” and has defaulted on the commitment.

3. Merchant Database

Turning to FIG. 7, a tabular representation of an embodiment of a merchant database 212 according to some embodiments is illustrated. This particular tabular representation of a merchant database 212 includes two sample records or entries which each include information regarding a particular merchant. In some embodiments, a merchant database 212 is used to record, process and/or track information about the merchants (e.g., information identifying or regarding a financial account of the merchant, the amount the merchant owes for benefits having been provided to customers on behalf of the merchant). Such a merchant database 212 may include any number of entries.

The particular tabular representation of a merchant database 212 depicted in FIG. 7 defines a number of fields for each of the entries or records. The fields may include: (i) a merchant identifier field 700 that stores a representation uniquely identifying the merchant; (ii) a financial account identifier field 702 that stores a representation of a bank, credit card, or other financial account number for charging the merchant for providing benefits to customers; and (iii) an amount owed field 704 that stores a representation of the amount the merchant owes (e.g., for providing benefits to customers).

The example merchant database 212 of FIG. 7 provides example data to illustrate the meaning of the information stored in this database embodiment. A merchant identifier 700 (e.g. 251M, 693M) may be used to identify and index the different merchants listed in the merchant database 212. The records may include a financial account identifier (represented by an account number, e.g. “3333-3333-3333-3333,” “4444-4444-4444-4444”) that may be specified to facilitate billing or actually charging merchants for services rendered, i.e. delivering new customers and providing benefits. Finally, the records may store accounting information such as amounts owed by the merchants (e.g. “$4500,” “$2420”) for services rendered to the merchants. According to other embodiments, other fields may be used to record, process and/or track, for a particular merchant, amounts owed for different activities, and different accounts to make payments or receive payments.

4. Dispensing Devices Database

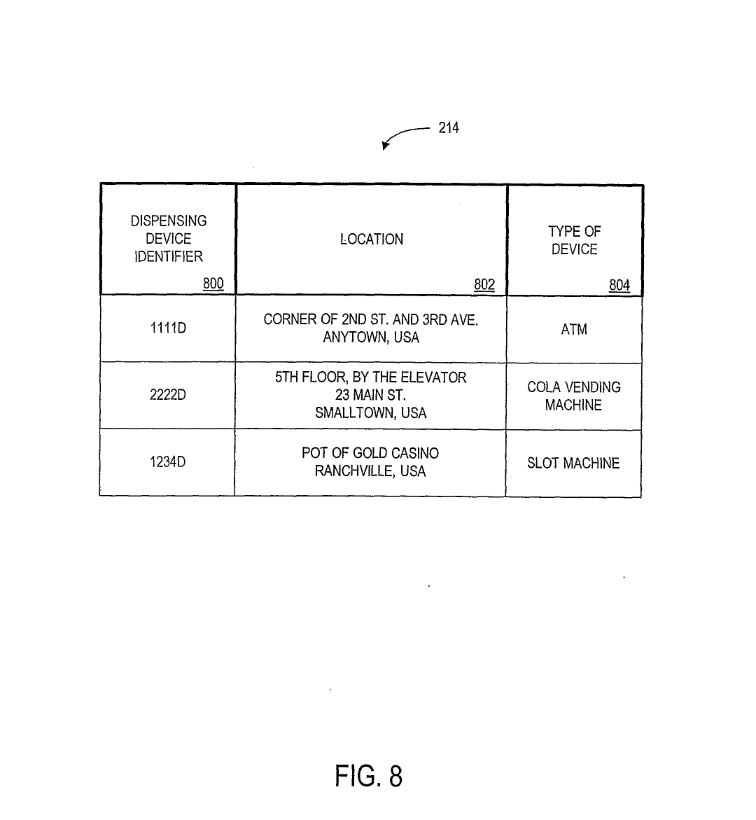

FIG. 8 illustrates a tabular representation of an embodiment of a dispensing devices database 214. This particular tabular representation of a dispensing devices database 214 includes three sample records or entries which each include information regarding a particular benefit-dispensing device. In some embodiments, a dispensing devices database 214 may be used to record, process and/or track such things as the type and location of each benefit-dispensing device. Those skilled in the art will understand that a dispensing devices database 214 may include any number of entries.

In an embodiment, a dispensing devices database may include a communication address of (or other information needed or desirable for communicating with) one or more benefit-dispensing devices, such as vending machines. For example, for each vending machine listed in the dispensing device database, an Internet Protocol (IP) address, a network address, a phone number, an email address, and/or the like may be stored. Such a communication address may be accessed by controller 102 and/or merchant device 112, 114, 116, so that, for example, a dispensing request or command may be directed and/or transmitted to one or more dispensing devices (such as vending machines) upon a customer's acceptance of a forward commitment offer, for example, through a user device in communication with the controller 102 or merchant device 112, 114, 116.

The particular tabular representation of a dispensing devices database 214 depicted in FIG. 8 defines a number of fields for each of the entries or records. The fields may include: (i) a dispensing device identifier field 800 that stores a representation uniquely identifying at least one benefit-dispensing device; (ii) a location field 802 that stores a representation identifying where the dispensing device is currently located; and (iii) a type of device field 804 that stores a representation describing what additional functions the dispensing device may have. The representation identifying where the dispensing device is currently located may include information that is primarily adapted for human reading (e.g., to inform a human reader) and/or for machine interpretation (e.g., to facilitate easy entry into another database or program, to facilitate processing by a program such as a program which plans driving routes for restocking).

The example dispensing devices database 214 of FIG. 8 provides example data to illustrate the meaning of the information stored in this database embodiment. A dispensing device identifier 800 (e.g. 1111D, 2222D, 1234D) may be used to identify and index the different dispensing devices listed in the dispensing device database 214. The location field 802 and the type of device field 804 may provide a description that allows a merchant to decide, for example, to choose where he would prefer to acquire customers. In the first sample entry, the location information conveys that the ATM dispensing device is located at a street intersection. In the second sample entry, the location information conveys that the cola vending machine dispensing device is located in a building on Main Street. In the third sample entry, the location information conveys that the slot machine dispensing device is located within a casino building.

An advantage of various embodiments is that such different types of dispensing devices, in different locations, may provide merchants with access to different types of customers with different motivations and obligations. Further, the different dispensing devices may provide different benefits according to various criteria. For example, a cola vending machine dispensing device in a downtown building may offer a free soda to an office worker willing to commit to buying his lunch at a local deli while a slot machine dispensing device may offer free plays to a vacationer willing to switch his current lodging choice to the casino's hotel.

### Processes

The system discussed above, including the hardware components and the databases, are useful and appropriate for performing various methods of various embodiments. However, not all of the above-described components and databases are necessary to perform any methods. In fact, in some embodiments, none of the above-described components need be used to practice various methods of various embodiments. For example, the customer database 210 described above is useful for tracking customers and information about them, but it is not absolutely necessary to have such a database in order to perform the methods described. The methods described herein could be practiced using instead, e.g., a conventional customer list in conjunction with a transaction log.

FIG. 9 illustrates an example process according to an embodiment that may be performed, e.g., by the controller 102 (FIGS. 1A and 1B), a third party, and/or an integrated third party entity/device such as a third-party server 118. For simplicity only, the example process of FIG. 9 is occasionally described below as being performed by a controller.

In Step S1 of FIG. 9, the system identifies a customer proximate to a benefit-dispensing device. In Step S2, information about the customer is received. In Step S3, a forward commitment offer is provided to the customer. In Step S4, an indication of whether the customer accepts the forward commitment offer is received. In Step S5, the benefit-dispensing device enables the provision of the benefit to the customer if the customer accepted the offer. In Step S6, it is determined whether the customer fulfilled the commitment, and in Step S7, a consequence is imposed if the customer has not fulfilled the commitment.

In the description that follows, each of these seven steps S1 through S7 is discussed in greater detail.

S1. Identify a Customer Proximate to a Benefit-dispensing Device

In Step S1, a customer near a dispensing device 106 is recognized as a potential candidate for a forward commitment agreement. In some embodiments, the dispensing device 106 recognizes a customer in its proximity by receiving a card belonging to the customer. The card may be, e.g., a card corresponding to a financial account (e.g., a credit card, debit card, ATM card), a player-tracking card, a frequent shopper card, a prepaid account card (e.g., a card that enables customers to prepay for vending machine products and redeem such products over time).

The benefit-dispensing device 106 may recognize a customer through the customer's transacting or interacting with the device. For example, a vending machine senses that coins are deposited and a beverage is selected. A customer may press a button to indicate his presence to the dispensing device 106. Customers may also be identified using voice recognition, infrared detection, motion detection, image recognition, and other known well techniques. In some embodiments, a human associate of the dispensing device 106 may identify people and indicate to the dispensing device 106 when a customer has become proximate to the dispensing device 106. In other embodiments, a customer's PDA, cell phone, or other device may alert the dispensing device 106 to the customer's proximity using, for example, a wireless protocol (e.g., Bluetooth™) or by the dispensing device otherwise detecting a device of the customer (e.g., through RFID transceivers, through detecting a unique RF signature of the customer's cell phone).

Once identified, a customer's identifying information may be stored in a database such as, for example, the customer database 210 of FIG. 6.

S2. Receive Information About the Customer

In Step S2, the system 100 receives information about the customer to determine whether a forward commitment may be acceptable to him, and if so what type of forward commitment offer is appropriate.

In some embodiments, information about the customer is received via the input device 308 and/or the card reader 310 of the dispensing device 106. In other embodiments, information about the customer is received from a user device, either directly or indirectly (e.g., via a telephone company's network, routers, switches, servers and the like). For example, the controller 102 may receive and interpret a customer's (cellular) telephone number by employing Automatic Number Identification (ANI) technology in a known manner.

In some embodiments, the system 100 may retrieve information about the customer from its own databases and/or other online databases maintained by third parties such as credit reporting bureaus, for example. In some embodiments, the information is useful for determining whether it is appropriate to offer a customer a forward commitment offer. For example, in one embodiment, a customer who has previously accepted a forward commitment offer but has failed to perform under the terms of the agreement may be identified and designated as blocked from receiving additional offers. Alternatively, a customer who has previously accepted/previously rejected a particular forward commitment offer may be designated as not eligible to receive the same or similar offers in the future/within a predetermined time period (e.g., within a month of such previous acceptance, previous rejection).

Further, in some embodiments the customer information is also useful for determining benefits that would be appealing to the customer. A customer's existing obligations provide a useful insight into what the customer may already be planning to do, and thus, may be helpful in identifying a forward commitment that the customer may choose to accept.

According to various embodiments, a customer's existing obligations describe actions a customer may feel some pressure to perform. The pressure may come out of physical necessity. For example, a customer is ultimately obligated to eat and to sleep. Obligations may stem from social pressure. Thus, a customer away from home may be obligated to stay at a hotel. Obligations may also arise from financial pressure, peer pressure, from a promise made, from moral duty, from fear, from pride, and so on. Typical customer obligations may include eating out at a restaurant, flying to a destination, filling a car with gas, getting a car's oil changed, fixing a car's dented bumper, opening a checking account, getting a new credit card, getting an annual physical examination, buying cereal, getting a hotel room for the night, sending a child to summer camp, finding a baby-sitter, getting a shirt mended, hiring a lawn-mowing service, getting a hairdo, filling tax returns, and taking a pet for vaccinations.

In addition to obligations, a customer may disclose one or more intentions of interest to the benefit-dispensing device 106. For example, a customer may indicate that he intends to take a vacation, though he may not be obligated to do so.

After being prompted, or of his own volition, a customer may communicate his obligations and/or intentions to the dispensing device 106. Communication may occur through keys, touch screens, voice input, wireless technology, or any other mode. The customer may also communicate proof or evidence of an obligation, such as a code that confirms a hotel reservation in a person's name. The customer may, in addition, communicate other personal information, such as a name, demographic description, address, purchasing history, hobbies, profession, and so on. Any such information may then be stored in a database such as, for example, the customer database 210 depicted in FIG. 6.

In obtaining information about a customer, the dispensing device may engage the customer in a survey. The survey may be “interactive” by determining new questions based on answers to prior ones. The survey may be designed to elicit those characteristics of a customer that could help determine if the customer is either suitable or unsuitable for a forward commitment. Thus, for example, if a customer mentions he is a Mercedes owner in response to a first question, a second question may ask whether he lives near a particular luxury-car dealership. In this way, a customer may be scrutinized as a candidate for a forward commitment requiring a test-drive of a new Audi® at a particular dealer.

A customer may record obligations on a user device such as a PDA. This may occur with customary use of such devices, as with a customer's appointment calendar, address book, and/or shopping list. An appointment calendar may not always include appointments per se, but may include, for example, notices of friends' birthdays, with the implicit reminder to buy a card or a gift. These obligations may then be accessed by the controller 102 (and/or the third party server 118) via a dispensing device 106 that is in communication with the user device. For example, if a customer has listed an appointment in his PDA to “Meet Jan at the Woolworth building at 3:00 PM on May 21” and the customer grants an ATM-type dispensing device 106 permission to access his PDA's data, the customer's PDA may communicate that appointment data, via e.g. infrared transmissions, to the ATM dispensing device 106. The ATM dispensing device 106 may then transmit the appointment information to the controller 102. As will be discussed below with regard to other steps of various methods, an operator and/or a computer program 206 may interpret the meaning of the appointment data received by the controller 102. In view of the appointment data, the controller 102 may present a forward commitment agreement to the customer, via the ATM, whereby the customer may choose to commit to using a particular cab company to reach the Woolworth building on May 21.

In some embodiments, a customer may choose to record his intentions and/or obligations on his user device expressly for the purpose of allowing the controller to become aware of his intentions and/or obligations. This may be the case even when the record of the intentions and/or obligations do not serve as a reminder for the customer himself.

Thus, the receipt of information regarding a customer's obligations, intentions and other information may allow the system 100 to provide benefits tailored to a particular customer and to determine commitments that the customer may be predisposed to accept.

S3. Present a Forward Commitment Agreement to the Customer

In Step S3, the controller 102 (and/or the third party server 118) determines a benefit, a forward commitment, and optionally a consequence to present via the dispensing device 106 and/or the user device to the customer as a forward commitment offer.

(i) Identify a Benefit Based on the Information About the Customer

Benefits may include the provision of: cash, equity, options, gambling tokens, stamps, tickets, consumable products (e.g. snacks, candy, sodas, bottled water, iced tea), toys, other products, services, insurance policies, and honorary titles. Products may be in the form of information such as audio and/or video recordings, driving directions, a person's weight, ring tones for a customer's cell phone, etc. Entertainment products, such as music videos may be displayed directly through an output device of the dispensing device 106, or transferred in binary form to a customer's user device, such as a PDA or cell phone. Benefits may include product add-ons or “upsells”, such as warranties. Services may include: clothes washing, car washing, etc. In some embodiments, identifying a benefit may entail deciding whether to offer a benefit at all.

For a gaming device-type dispensing device in particular, benefits may include the provision of: cash; credits; gambling tokens; reward points; cashless gambling receipts; increased odds of winning; increased prize tables; insurance against losses; the ability to play a large denomination machine for a small denomination; the free use of an extra slot in a multi-slot machine; being permitted to play for free; having winnings rounded or adjusted to a higher level (e.g. $85 rounded to $100); the enablement of extra prize-winning symbols on a slot machine; the enablement of extra pay lines on the slot machine; discounts on various products; and auxiliary benefits, such as free or subsidized meals or hotel rooms.

A benefit to be offered a particular customer and/or customers in general may be identified based on a number of factors. These factors may include: whether the benefit is likely to sufficiently motivate a customer (and/or the present customer) to enter into and/or to fulfill a forward commitment agreement; the value to the system 100 and/or to a merchant of binding the customer in a forward commitment; the benefits the dispensing device 106 can actually physically dispense at the moment (e.g. a given vending machine may temporarily be out of stock of a particular product); revenue management principles (as detailed in the book by Robert G. Cross entitled “Revenue Management: Hard-Core Tactics for Market Domination”, published 1997, by Broadway Books, which is incorporated by reference herein in its entirety); and any predefined strategy for dispensing a limited number of benefits amongst multiple potential entrants into forward commitment agreements.

Information about the customer may reveal which benefits may be particularly motivational and when to offer the benefits. For example, a customer at a slot machine-type dispensing device 106 who has just lost $50.00 may be quite embarrassed and therefore highly motivated to accept a $50.00 benefit for entering into virtually any reasonable forward commitment. Likewise, a customer at an ATM-type dispensing device 106 who requests to withdraw $50.00 but has only $35.00 in his account may be motivated to accept a $15.00 cash benefit. Further, a customer at a gas pump-type dispensing device 106 who has lost his wallet and needs gas to reach home may be motivated to accept five gallons of gasoline as a benefit.

In identifying a benefit, the controller 102, a merchant, and/or the third party server 118, may calculate the value of having a particular customer commit to a particular forward commitment, and may then offer a portion of that value to the customer as a benefit. Such a portion could be reflected in, e.g., the benefit field 506 of FIG. 5.

For example, a credit card company might calculate that it makes an average of $300.00 from every female cardholder over the duration of the cardholder's business with the credit card company. The credit card company may thus choose to offer $150.00 dollars to a customer using a vending machine-type dispensing device 106 located in a woman's locker room in exchange for committing to sign up with the company. The credit card company may choose to extend such an offer based on anticipating a $150.00 profit resulting from signing up the customer (less any fee provided to the system 100). Having determined the value of the average female customer, the credit card company may notably choose to never offer more than a $300.00 benefit to an individual woman unless special circumstances are involved.

Similarly, the aggregate value of having a plurality of customers commit to forward commitments may be calculated, and portions of that aggregate value may be offered to various of the plurality of customers as a benefit. Thus, certain customers could actually receive more than the value of having that particular customer commit to a particular forward commitment. Such an aggregate value could be reflected in, e.g., a budget field of a forward commitment database, as described above.

In a casino setting, the controller 102 might calculate the value of having a gambler play on a gaming device for an extra hour. The calculation may be based on the gambler's rate of play and on the hold percentage of the gaming device. A gaming device's “hold percentage” is defined as one minus the ratio of the number of coins paid to the number of coins collected in wagers over a complete cycle of the gaming device. An exemplary formula for calculating a value to the casino of an extra hour's play on a “$1 machine” (i.e. $1 wager per play) gaming device is:
Value=(Rate of Play in plays 1 hour)*(1 hour)*($1/play)*(Hold Percentage per play)

The casino could, via a dispensing device that is a gaming device, offer a portion of the computed value as benefit to the gambler in return for the gambler committing to playing for an extra hour.

The controller 102, a merchant, and/or the third party server 118, may also calculate a typical customer acquisition cost. The controller 102 or merchant may then be willing to allow a dispensing device 106 to offer a benefit with value up to the cost of customer acquisition.

In some cases, the benefit offered may depend on the funds available to be dispensed by the dispensing device 106. For example, if a slot machine-type dispensing device 106 has only $30.00 worth of coins in its hopper, the benefit offered could be constrained not to exceed $30.00. Even if a dispensing device 106 has sufficient money or products inside of it to provide a particular benefit, the contents of the machine may instead be preserved for other benefits, or for the normal use of the machine. For example, if an ATM-type dispensing device 106 has only $200.00 remaining, even small benefits may not be offered so that there will be money available for bank customers simply wishing to withdraw funds. Alternatively, small benefits may not be offered to moderately desirable customers so that a large benefit may be offered to a highly desirable customer. In deciding when to offer benefits, the dispensing device 106, or the controller 102/third party server 118, may use algorithms that consider the frequency with which the device is used, the types of customers that use the device, revenue and/or inventory management principles, and when and how often the contents of the device are replenished.

The determination of a benefit, including the determination to offer none at all, may further depend on a customer's perceived trustworthiness. If a customer is deemed only 50% likely to fulfill a commitment to sign up for a credit card, the value of the forward commitment to the credit card company may decline by 50%, and the benefit offered the customer may be reduced accordingly.

A benefit offered to the customer may not correspond directly to the value of the forward commitment. For example, a benefit may be disproportionately large in order to show appreciation to a loyal customer, or to earn the loyalty of a new customer.

A benefit offered to a customer may depend on influences from a merchants' competitors. For example, a fitness club looking to acquire new members may authorize a beverage vending machine-type dispensing device 106 located outside a competitor's club to offer a bottle of juice as a benefit to a customer in return for entering into a forward commitment to exercise three times at the fitness club. The value of the benefit offered may be increased if there are numerous competing fitness clubs near the benefit-dispensing device which might divert the customer's attention.

(ii) Identify a Forward Commitment Based on the Information About the Customer

In addition to a benefit, the system 100 will also identify a forward commitment to be fulfilled by the customer in exchange for the benefit. As indicated above, the forward commitment identified may be based on information about the customer's existing obligations. Merchants may periodically submit, via merchant devices 112, forward commitments to the controller 102 for subsequent offering to customers. Alternatively, merchants may register forward commitment offers through the input and output devices of one or more benefit-dispensing devices and/or user devices. For example, a merchant having a place of business within the same geographical proximity as a vending machine may register, through the vending machine or a nearby kiosk, a forward commitment offer to be provided to one or more customers, enabling customers to receive free product from the vending machine provided they agree to transact with the merchant at some point in the near future. Thus, with the forward commitments, the merchants may include an amount of benefit to be paid to a customer should the customer assume the forward commitment.

The merchant might further specify a fee he is willing to pay the system 100 (including an operator of a benefit-dispensing device such as a vending machine) for each customer the system 100 enters into a forward commitment agreement. Of course, many other fee structures are possible.

The merchant may further provide descriptions of customers that the merchant desires to have enter into the forward commitments agreements. Descriptions may include age, demographic information, purchasing history, family size, height, weight, shoe size, gender, etc. Merchants may additionally specify the number of customers they desire to enter into forward commitment agreements.

Forward commitments, benefits, fee specifications, quantity specifications, and descriptions of customers may be stored by the system 100 in a database such as, for example, the forward commitment database 208 depicted in FIG. 5. The controller 102 may access relevant commitments from the database 208 when a suitable customer interacts with a dispensing device 106. The controller 102 may use a rules-based system to determine an appropriate forward commitment or, in some embodiments, an operator of the controller 102 and/or merchant device 116 may determine appropriate forward commitments. In some embodiments, the forward commitments may be selected or derived using artificial intelligence.

Some specific examples of forward commitments may include: a commitment to eat at Joe's Pasta House on Oct. 6, 2003, and to spend at least $25.00; a commitment to fly from JFK airport in New York to O'Hare airport in Chicago using United Airlines®, the flight occurring in the next 60 days; a commitment to buy 10 gallons of gasoline weekly from a Mobil® station for the next 12 weeks; a commitment to open a checking account with Fleet Bank® within the next 15 days; a commitment to play at a slot machine for another hour; a commitment to a consultation with a life-insurance agent; a commitment to test drive a new car; a commitment to limit cereal purchases to Quaker® brand cereals for the next six months; a commitment to pay for a magazine subscription; and a commitment to sign up for a Chase® credit card and to transfer $1,000.00 in existing balances to the new card.

In some embodiments, a forward commitment may be determined directly based on selecting a commitment that requires the customer to satisfy an existing obligation in a particular way. For example, if the customer has a long drive commuting to work, and therefore purchases gasoline frequently, then the system 100 may offer the customer a forward commitment to buy 10 gallons of gasoline per week from Mobil®.

In some embodiments, forward commitments may be determined by examining the implications of existing obligations. For example, if a vacationer is a registered guest at a merchant's hotel for the next three nights, then it may be assumed the vacationer may likely be dining at local restaurants for the next three days. Thus, a vending machine-type dispensing device 106 located in the hotel lobby may offer a benefit (e.g. a beverage) in exchange for a forward commitment to dine at the merchant's restaurants for the next three days.

(iii) Identify a Consequence For Not Fulfilling the Commitment

In some embodiments, the controller 102 may optionally “secure” the forward commitment by imposing a penalty for breach of the forward commitment agreement. Such a penalty may be implemented by retaining financial account information of the customer. In an embodiment, the penalty is known a priori to be a penalty which can be imposed with little effort and/or the penalty includes an amount of money which is known a priori to be readily collectable. For example, the financial account may be billed (e.g., without requiring the customer's consent) if it is determined that the customer has not fulfilled the forward commitment (e.g., within a required time period). The amount billed may relate to the value of the benefit provided, interest on the benefit, costs associated with processing forward commitment information, and any other fees or penalties.

In some embodiments, the consequence may restrict the customer's access to one or more benefit-dispensing devices 106. In one embodiment, if a customer has breached the terms of an existing forward commitment agreement, he may be prevented from transacting with the benefit-dispensing device in any manner. For example, in an embodiment where a benefit-dispensing device comprises a vending machine, a customer who has breached the terms of an existing forward commitment agreement may be prevented from purchasing products from the vending machine. In another embodiment, the consequence may be that the customer is prevented from receiving one or more future benefits from the benefit-dispensing device. For example, a customer may accept a forward commitment offer that provides the customer with the ability to receive one product (e.g. a soda) from benefit dispensing device (e.g. a vending machine) for each period of time that he continues to transact with a merchant (e.g. each month that he remains a subscriber of a magazine). Should the customer cease transacting with the merchant, his ongoing benefits may cease (e.g., he may stop receiving codes that can be presented to a vending machine in exchange for products); should he continue transacting with the merchant, his ongoing benefits may continue (e.g., he may continue receiving codes, via user device or through the mail, that can be presented to a vending machine in exchange for products).

In some embodiments, the consequence may be a ban or restriction on the customer from entering into future forward commitments. For example, if a customer has breached the terms of an existing forward commitment agreement, he may not receive one or more forward commitment offers in the future.

In some embodiments, the consequence may require the return or revocation of the benefit provided. For example, if the benefit is a product, the system 100 may require that the product be returned. The product might be returned directly to the dispensing device 1006, or to an affiliated party, such as a merchant.

In some embodiments, the controller 102 may send a warning message (e.g. email, text message) to the customer, encouraging him to fulfill his forward commitment and possibly warning of other consequences if he does not. The system may initiate legal action against the customer in order to enforce the terms of the forward commitment agreement, or to recover damages incurred.

(iv) Present the Agreement to the Customer

The offer may be presented to the customer in many different ways including: via text displayed on an LCD or other display screen or device; via back-lighting pre-composed text; via a signal or message sent to a user device, such as a PDA or cell phone; via text printed on a paper (e.g. printed through a thermal receipt printer of a vending machine); via a computer synthesized voice output through a speaker; via a pre-recorded voice output through a speaker; via a live voice output through a speaker; and/or via a Braille representation.

In some embodiments, offers of commitment agreements may be sent to a customer's device (e.g. PDA), but not revealed immediately. The offers may not be revealed until the customer has demonstrated an obligation or intention. For example, an offer of $50.00 in return for entering into a commitment to fly Delta Airlines® may only be revealed to a customer whose PDA is set to Eastern Standard Time (EST) when the customer enters an appointment to meet a friend in San Francisco. Offers may also be revealed based on a customer's location. In particular, offers may be revealed if a customer is proximate to a benefit-dispensing device 106.

The offer of the forward commitment agreement may include a complete description of the forward commitment, the benefit to be provided, and any consequence or penalty to be imposed should the customer enter into, but not fulfill the forward commitment. The offer may further include a description of the customer's legal rights and obligations in entering into the forward commitment agreement.

S4. Receive an Indication that the Customer Accepts the Forward Commitment Agreement

In Step S4, the customer indicates his acceptance or rejection of the offered forward commitment agreement. If the customer rejects the offer, the illustrated process ends. In some embodiments, the system may present an alternate offer or modify the existing offer to make it more appealing. If the customer accepts the offer, the controller 102 signals the dispensing device 106 to provide the customer with the benefit.

According to various different embodiments, a customer may indicate his acceptance of a forward commitment agreement in many different known ways including: pressing an “accept” or similar button on a dispensing device 106 or a touch screen of the device; pressing a button of a user device, such as a cell phone or PDA; verbally communicating his acceptance to a benefit-dispensing device 106 or a user device; signing a written document and, optionally, inserting the executed document into the dispensing device 106; providing a signature on a touch screen with a stylus; providing a finger print; providing a retinal scan or other unique biometric, providing a print or a number of a credit or debit card; transmitting a written, electronic, or voice message to a phone number or address designated by the controller 102 via the dispensing device 106.

Thus, in some embodiments, a customer may indicate his acceptance of a forward commitment offer to a benefit-dispensing device. In other embodiments, a customer may indicate acceptance of a forward commitment offer to via user device, such as a PDA. The user device may communicate directly with controller 102, indirectly with controller 102 via benefit-dispensing device 106, 108, 110, or only with benefit-dispensing device 106, 108, 110.

S5. Provide the Benefit to the Customer Via the Dispensing Device

In Step S5, the benefit-dispensing device 106 provides the benefit, be it cash, tokens, stamps, tickets, coupons, phone time, consumables (e.g. snacks, candy, soda, water, etc.), product, information, or service in response to a signal to do so from the controller 102, the third party server 118 and/or a user device, such as a PDA or cell phone.

The benefit may be provided via a benefit dispenser 314, such as those possessed by ATMs for dispensing cash, those possessed by slot machines for dispensing tokens, or those possessed by vending machines for dispensing goods (e.g. consumables). Information may be dispensed on a machine-readable medium, such as a floppy disk, a CD, a flash drive or a DVD. In an alternate embodiment, information may also be transmitted from the benefit-dispensing device to a customer device, such as a PDA or cell phone.

In an embodiment where a customer receives and/or accepts a forward commitment offer via a user device such as a PDA or cell phone, the controller 102 may transmit a code, binary file or other signal the user device. The customer may, in turn, use the binary file or other signal to obtain a benefit, such as a consumable product, from the benefit-dispensing device, such as a vending machine. Before dispensing a benefit, the benefit-dispensing device may first confirm that the customer is in fact entitled to receive a benefit by evaluating the code, binary file or other signal in light of data stored in a local or remote database, such as a database of controller 102. For example, the benefit-dispensing device may confirm the validity of a code presented by a customer by determining if the code exists in a local database, or by querying the controller 102 to determine if the code exists in a remote database (e.g. a database of the controller 102).

In one embodiment, a controller 102 or a third party server 118 transmits an alphanumeric code to a customer's user device, which outputs the code to the customer via an output device, such as an LCD screen or a speaker. The customer may then enter the code into an input device of the benefit-dispensing device such as, for example, the keypad of a vending machine.

In another embodiment, a controller 102 or a third party server 118 transmits machine-readable signals (e.g., printed or displayed indicia, audio, RF signals) to a user device. The customer may, in turn, present the machine-readable signals (e.g., printed or displayed indicia, audio, RF signals) to the benefit-dispensing device. For example, the customer may hold the user device in proximity to an input device of the benefit-dispensing device. In one embodiment, the user device may receive (e.g., from the controller 102 or third party server 118) information in a bar code format, which the benefit-dispensing device in turn may optically read from the user device's LCD screen and thereafter interpret or decode. The user device may receive (e.g., from the controller 102 or third party server 118) information defining DTMF tones, which are subsequently output through a speaker of the user device to a microphone of the benefit-dispensing device. Other data communication mediums and formats are also contemplated, including infrared signals, RF signals and the like.

S6. Determine if the Customer Fulfilled the Commitment

In Step S6, the system 100 determines whether the forward commitment has been fulfilled. If the customer has fulfilled the forward commitment, processing stops. If not, processing proceeds to Step S7.

In some embodiments, the controller 102 may examine transaction records of the customer. Transaction records may include a credit card billing history or a purchasing history maintained in a frequent shopper account. From these transaction records, the controller 102 may determine, for example, whether a customer has dined at a restaurant where he had agreed to dine. One provision of the forward commitment agreement may be that the customer grants the controller 102 access to any records that allow it to verify satisfaction of the forward commitment. In such an embodiment, the controller would be operable to access and interpret such records in any of a number of known manners.

In some embodiments, the customer may submit to the controller 102, receipts, ticket stubs, menus, UPC codes, pictures, casino tokens, or any other acceptable proof that the customer has fulfilled his forward commitment. The failure to provide such proof within a defined time period, may be defined to be a default. In other embodiments, a merchant may call or access the controller 102 and/or the third party server to verify that the customer has, for example, transacted with the merchant in accordance with a forward commitment agreement.

S7. Impose the Consequence if the Customer Defaulted on the Commitment Agreement

In Step S7, the controller 102 causes the consequence to be imposed upon the customer. Thus, depending on the consequence as agreed to in the forward commitment agreement, the controller 102 may take many different actions including: billing a financial account associated with the customer; flagging the customer's name, phone number or other identifier in a database so that the customer is restricted from entering into future forward commitments; flagging the customer's name, phone number or other identifier in a database so that the customer is restricted from using the benefit-dispensing device; sending the customer a warning message via, for example, email, fax, and/or postal mail; and initiating legal action against the customer.

### EXAMPLE ILLUSTRATIVE EMBODIMENT

The following example illustrates one sample embodiment.

Tom Jones, while walking along the sidewalk, noticed a vending machine stocked with snacks. Hungry, he decided to approach the vending machine to purchase an item. However, he realized that he did not have enough cash to purchase an item. Nonetheless, Tom saw a sign posted on the machine reading, “Get a free snack if you purchase a subscription to Sports Illustrated® magazine. Just call 1-800-SUBSCRIBE now!”

Tom used his cell phone to call the number, and was prompted by an IVR system to provide his name, address and credit card number. After doing so, the IVR system output a ten-digit code to Tom's cell phone along with instructions to present the code to the vending machine to receive his free item. The code and the instructions appeared on the LCD screen of his cell phone.

Tom entered the code using the vending machine's numeric keypad. In response, the vending machine's control system confirmed the code by referencing a local database.

The operator had previously received a batch of promotion codes from the publisher of Sports Illustrated® upon entering an agreement to promote the magazine through the vending machine. Before Tom's transaction, these codes had been stored by the operator of the vending machine in a local database. Having thus confirmed the validity of the code, the vending machine control system (1) permitted Tom to select one snack, (2) dispensed the snack, and (2) recorded the transaction in a database.

Subsequently, the vending machine's operator retrieved the transaction data from the database, and submit a bill to the publisher of Sports Illustrated® for the cost of the product, plus a $0.25 “customer acquisition fee”. Thus, Tom received a free snack item and a subscription to Sports Illustrated®, the vending machine operator profited by $0.25, and the publisher of Sports Illustrated® acquired a new customer.

### ADDITIONAL EMBODIMENTS

The following are example alternative variations that illustrate additional embodiments. It should be understood that the particular variations described in this section can be combined with the different embodiments, or portions thereof, described above in any manner that is practicable or desirable.

Various embodiments may include the additional step of verifying that the customer is legally able to enter into a forward commitment agreement. For example, a forward commitment agreement may be considered legally unenforceable only if the customer is under the age of eighteen. Thus, the controller 102 may, for example, consult a database of publicly available birth records to determine the age of the customer. The dispensing device 106 may also scan or photograph an ID, such as a driver's license or passport belonging to the customer, and perform optical character recognition to determine the age from printed indicia. If the customer possesses an item, such as a credit card, that is given out on a restrictive basis (e.g., only to people of a certain age), then the controller 102 may infer the customer's eligibility from the customer's possession and/or presentation of that item.

In some embodiments, the dispensing device may use a built-in printer to print a generic or customized document describing the forward commitment. The customer may enter into the forward commitment by signing the document. A camera built into the dispensing device 106, or proximate to the dispensing device may record the signing and thereby act as a witness. The customer may insert the executed document, or a carbon copy of the executed document, into the dispensing device.

In some embodiments, a customer device, such as a PDA, may enter into forward commitments on behalf of its owner or another person. The device may be preprogrammed to enter into forward commitments based on predefined parameters.

For example, a customer may program his combination cell phone/PDA to accept any forward commitment agreement to dine at a local restaurant for $50 or less, in return for free phone minutes. Then, when the customer walks by a phone card vending machine-type dispensing device 106, the vending machine may broadcast, via infrared frequencies, a forward commitment agreement to dine at Sam's Mexican Diner in the next week in return for 50 phone minutes. The cell phone/PDA may then accept the offer on the customer's behalf by beaming back the customer's identifying information. The cell phone/PDA may subsequently alert the customer that he has entered into a forward commitment.

In some embodiments, the forward commitment may require the customer to download processor instructions onto a customer device. The computer instructions will cause the device to fulfill the forward commitment. In such embodiments, part or all of the responsibility of fulfilling the commitment is transferred to the customer device.

For example, a forward commitment may require a cable box to receive instructions to tune to channel 45 on Sunday from 3:00 PM to 5:00 PM and at the same time block reception of any other channels. At the appointed time, the cable box may turn on the television, tune to channel 45, and play the relevant show. The customer is relieved of having to remember when and what channel to watch, and merely needs to be present during the designated time period. In a similar example, a forward commitment may require a customer to load software onto his personal computer (PC) that provides the controller with information gleaned from the PC.

In other embodiments, entering into a forward commitment may entail making a networked device available for the use of others. For example, a customer may make his PC's computing cycles available for detecting extra-terrestrial signals when the PC is not otherwise in use. A related benefit may be to provide another customer use of the first customer's PC computing cycles.

In some embodiments, forward commitment agreements may include buyout or other termination provisions. Thus, a customer who is unable to fulfill a forward commitment, may choose to: compensate the controller 102, find an alternate person to fulfill his forward commitment, and/or enter into a new forward commitment. In some embodiments, the controller 102 may agree to modify deadlines or other terms associated with the commitment simply because the customer has shown good faith by notifying the controller 102 of his inability to fulfill the commitment.

Various embodiments may include the additional step of alerting a merchant that a customer has entered into a forward commitment involving that merchant. For example, the customer has agreed to dine at the merchant's restaurant.

Various embodiments may include the additional step of the merchant reimbursing the controller 102 for any benefits provided to customers via benefit-dispensing devices 106. The controller 102 may keep track of money owed it by merchants in a database such as for example, a merchant database 212 as depicted in FIG. 7.

In some embodiments, customers may receive ratings based on how often they fulfill forward commitments. The ratings may be used in determining what benefits and forward commitments to offer the customer.

In some embodiments, forward commitments may include a commitment to make a purchase at a future time. The controller 102 may be granted the authority to make the purchase automatically on behalf of the customer. In this embodiment, the customer does not have to remember to make the purchase. For example, the customer may provide a financial account number and his home address when agreeing to a forward commitment to purchase an, as yet, unavailable product. When the product becomes available, the controller 102 may charge the customer's financial account automatically, and the product may be shipped directly to the customer's home address.

In an embodiment, a dispensing devices 106, particularly vending machine-type dispensing devices, may enter into forward commitment agreements with customers without the use of or any connection to a central controller. In such an embodiment, a maintenance person may visit the dispensing device 106 on a periodic basis and retrieve a record of the forward commitment agreements consummated by the dispensing device 106. This record, which would include information similar to that stored in the forward commitment database 208 and the customer database 210 described above, could be used to perform various steps described herein.

We claim:

1. A method comprising:
identifying a customer who is proximate to a vending machine;
receiving information about the customer;
outputting an offer to reduce the price of a product dispensable from the vending machine in exchange for assuming a forward commitment, in which the forward commitment agreement defines
a term that specifies a forward commitment, and
a term that specifies a reduction in a price of a product that is dispensable from the vending machine;
receiving an acceptance of the offer;
receiving a financial account identifier that identifies a financial account of the customer;
providing the product to the customer for a price that is less than a retail price of the product.

2. The method of claim 1, further comprising:
determining the reduction based on the customer.

3. The method of claim 2, in which the step of determining the reduction comprises:
determining the reduction based on a value of the customer assuming the forward commitment

4. The method of claim 1, further comprising:
determining a consequence of failing to fulfill the forward commitment.

5. The method of claim 1, further comprising:
determining whether the customer has fulfilled a forward commitment specified by the forward commitment agreement.

6. The method of claim 5, further comprising:
imposing a consequence on the customer if the forward commitment has not been fulfilled.

7. The method of claim 6, in which the step of imposing the consequence comprises:
charging the financial account of the customer.

8. A method, comprising:
providing, via a cellular telephone, an offer to enter into a forward commitment agreement;
receiving an acceptance of the offer;
making a code available to the cellular telephone after receiving the acceptance;
determining whether the code has been presented to a vending machine after the step of making the code available; and
dispensing a product from a vending machine after the step of determining.

9. The method of claim 8, further comprising:
determining whether a forward commitment specified by the forward commitment agreement has been fulfilled.

10. The method of claim 9, further comprising:
imposing a consequence if the forward commitment has not been fulfilled.

11. The method of claim 9, in which the step of imposing the consequence comprises:
charging a financial account.

12. The method of claim 8, in which making a code available to the cellular telephone comprises:
transmitting a code to the cellular telephone.

13. The method of claim 12, in which determining whether the code has been presented to a vending machine after the step of making the code available comprises:
receiving the code from the cellular telephone.

14. The method of claim 8, further comprising:
receiving an indication of at least one product that the customer is to purchase from the vending machine.

15. The method of claim 14, in which the step of providing the offer is performed after the step of receiving the indication.

16. The method of claim 14, in which the step of providing the offer is performed before the customer purchases the at least one product.

17. A method comprising:
identifying a customer who is proximate to a vending machine;
receiving information about the customer;
outputting an offer to reduce the price of a product dispensable from the vending machine in exchange for assuming a forward commitment;
receiving an acceptance of the offer;
providing the product to the customer for a price that is less than a retail price of the product.

18. the method of claim 17, further comprising:
determining an amount by which to reduce the price of the product.

19. The method of claim 18, in which the step of determining an amount by which to reduce the price of the product comprises:
determining an amount by which to reduce the price of the product based on the customer.

20. The method of claim 19, in which the step of determining an amount by which to reduce the price of the product comprises:
determining an amount by which to reduce the price of the product based on a value of the customer assuming the forward commitment

21. The method of claim 17, in which the step of outputting the offer comprises:
directing a cellular telephone to output the offer.

22. The method of claim 17, further comprising:
determining a consequence of failing to fulfill the forward commitment.

23. The method of claim 17, further comprising:
determining whether the customer has fulfilled a forward commitment specified by the forward commitment agreement.

24. The method of claim 23, further comprising:
imposing a consequence on the customer if the forward commitment has not been fulfilled.

25. The method of claim 24, in which the step of imposing the consequence comprises:
charging a financial account of the customer.
